(19) United States
(12) Patent Application Publication
(10) Pub. No.: US 2026/0196079 A1
(43) Pub. Date: Jul. 9, 2026

(54) SYSTEMS AND METHODS OF FACILITATING DYNAMIC ENTITY ASSOCIATION

(71) Applicant: Neotericc LLC, LONE TREE, CO (US)

(72) Inventor: Patrick L. Carter, Lone Tree, CO (US)

(73) Assignee: Neotericc LLC, LONE TREE, CO (US)

(21) Appl. No.: 19/435,939

(22) Filed: Dec. 30, 2025

Related U.S. Application Data
(60) Provisional application No. 63/739,825, filed on Dec. 30, 2024.

(51) Int. Cl. G06V 40/20; G06T 7/20

(52) U.S. Cl. CPC G06V 40/23; G06T 7/20

(57) ABSTRACT

The present disclosure provides a method of facilitating dynamic entity association. Further, the method may include receiving one or more content data. Further, the one or more content data corresponds to one or more physical activities. Further, the method may include analyzing the one or more content data using one or more tracking algorithms. Further, the one or more tracking algorithms may be configured to track two or more entities in the one or more content data. Further, the method may include determining one or more associations between one or more first entities and one or more second entities in the one or more physical activities based on the analyzing of the one or more content data using the one or more tracking algorithms. Further, the two or more entities include the one or more first entities and the one or more second entities.

### REFERENCE TO RELATED APPLICATIONS

This application claims the benefit of U.S. Provisional Ser. No. 63/739,825, titled “SYSTEMS AND METHODS FOR DYNAMIC PLAYER-ENTITY ASSOCIATION AND PERFORMANCE ANALYSIS IN SPORTS”, filed on Dec., 30, 2024, which is incorporated by reference herein in its entirety.

### FIELD OF DISCLOSURE

The present disclosure relates to the field of data processing. More specifically, the present disclosure relates to systems and methods of facilitating dynamic entity association.

### BACKGROUND

The field of the present disclosure generally pertains to computer vision, multi-entity tracking, and real-time performance analytics within sports environments. The field is of increasing importance as modern athletic training, competitive sports programs, broadcasting infrastructure, and automated analytics platforms place substantial emphasis on the accurate identification, association, and evaluation of participants and sport-related objects during high-speed physical activities. As the volume of digital sports content continues to grow and the demand for intelligent, real-time insight increases, the ability to automatically interpret complex interactions among players and sport objects becomes essential for improving training effectiveness, enhancing strategic decision-making, supporting officiating workflows, and enabling new forms of data-driven engagement.

In many scenarios across this field, there is a need to achieve precise, continuous, and semantically meaningful characterization of how a sporting action unfolds. Such characterization may include reliably determining which participant is interacting with which sport object, identifying which participant plays a primary role in a given event sequence, and evaluating the participant's performance using objective criteria. Achieving the above objective may allow downstream systems or users to extract higher-order understanding from raw video or sensor streams, including identifying key actions, assessing motion quality, detecting mistakes, or generating automated feedback.

However, difficulties arise when attempting to achieve the above objective using existing or known approaches. For example, systems may experience challenges when multiple players and sport objects occupy overlapping or crowded regions, causing ambiguity in determining which participant is associated with which object. Methods that rely on simplistic distance or proximity cues may fail when players obstruct one another or when the sport object becomes temporarily hidden. Further challenges may occur when the sport activity involves rapid movement, abrupt directional changes, or interactions that unfold over multiple frames, making it difficult for known tracking and analysis pipelines to maintain continuity and contextual understanding.

Additionally, existing systems may struggle to extract reliable performance indicators because they may not effectively capture temporal patterns, spatial configurations, or contextual cues defining a player's role or action. Moreover, real-time analysis may be hampered by computational inefficiencies, latency limitations, or an inability to adapt to varying visual conditions, camera motion, or differences in gameplay structure. The above limitations may result in inaccurate associations, incorrect participant identification, missed key actions, unreliable metrics, or insufficiently informative feedback.

Therefore, there is a need for improved methods and systems for facilitating dynamic entity association that may overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating dynamic entity association. Further, the method may include receiving, using a communication device, one or more content data from one or more content source devices. Further, the one or more content data corresponds to one or more physical activities. Further, the one or more physical activities may be associated with two or more entities. Further, the method may include analyzing, using a processing device, the one or more content data using one or more tracking algorithms. Further, the one or more tracking algorithms may be configured to track the two or more entities in the one or more content data. Further, the method may include determining, using the processing device, one or more associations between one or more first entities and one or more second entities in the one or more physical activities based on the analyzing of the one or more content data using the one or more tracking algorithms. Further, the two or more entities include the one or more first entities and the one or more second entities.

The present disclosure provides a system for facilitating dynamic entity association. Further, the system may include a communication device which may be configured for receiving one or more content data from one or more content source devices. Further, the one or more content data corresponds to one or more physical activities. Further, the one or more physical activities may be associated with two or more entities. Further, the system may include a processing device communicatively coupled with the communication device. Further, the processing device may be configured for analyzing the one or more content data using one or more tracking algorithms. Further, the one or more tracking algorithms may be configured to track the two or more entities in the one or more content data. Further, the processing device may be configured for determining one or more associations between one or more first entities and one or more second entities in the one or more physical activities based on the analyzing of the one or more content data using the one or more tracking algorithms. Further, the two or more entities include the one or more first entities and the one or more second entities.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

The drawings presented with this disclosure may illustrate representative and non-limiting arrangements of hardware components, software modules, artificial intelligence subsystems, machine learning architectures, data processing pipelines, user interfaces, network topologies, and memory arrangements that may be used to understand embodiments of the present subject matter. They may depict functional or conceptual layouts intended to facilitate explanation of the disclosed principles. The geometric appearance, dimensional proportions, ordering, grouping, and naming of elements within the drawings are not intended to imply any restriction on implementation. The drawings may schematically portray computing environments containing client devices, servers, distributed computing clusters, communication networks, storage systems, or artificial intelligence models arranged for training, inference, or combined operations. The drawings may include simplified symbolic representations of algorithmic processes, workflows, blocks, or modules; such symbolic representations are treated as abstractions of underlying hardware and software operations rather than literal structural requirements. Similarly, lines connecting components may represent logical associations, communication pathways, or data relationships rather than any specific physical wiring or layout. These figures may also illustrate non-exhaustive examples of operational stages, sequencing, or interactions among artificial intelligence components such as encoders, decoders, generators, discriminators, featurizers, transformers, or safety-validation modules. Any specific combination or configuration shown is presented for explanatory clarity only. Additional drawings, alternative views, or more granular depictions may be used without affecting the scope of the claims.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 is a block diagram illustrating a machine-learning system 300 for implementing various embodiments of this disclosure, in accordance with some embodiments.

FIG. 4 illustrates a flowchart of a method 400 of facilitating dynamic entity association, in accordance with some embodiments.

FIG. 5 illustrates a flowchart of a method 500 of facilitating dynamic entity association including identifying, using the processing device 804, each of the plurality of entities in the at least one content data using the at least one neural network, in accordance with some embodiments.

FIG. 6 illustrates a flowchart of a method 600 of facilitating dynamic entity association including analyzing, using the processing device 804, each of the at least one temporal data and the at least one spatial data of the plurality of entities, in accordance with some embodiments.

FIG. 7 illustrates a flowchart of a method 700 of facilitating dynamic entity association including identifying, using the processing device 804, at least one primary entity from the plurality of entities, in accordance with some embodiments.

FIG. 8 illustrates a block diagram of a system 800 of facilitating dynamic entity association, in accordance with some embodiments.

FIG. 9 illustrates a flowchart of a method 900 of facilitating dynamic entity association including generating, using the processing device 804, a feedback data, in accordance with some embodiments.

FIG. 10 illustrates a process 1000 of provisioning feedback on a physical activity of a composite object, in accordance with some embodiments.

FIG. 11A illustrates a flowchart of a method 1100 for dynamic player-entity association and performance analysis in sports, in accordance with some embodiments.

FIG. 11B illustrates a continuation of the flowchart of the method 1100 for dynamic player-entity association and performance analysis in sports, in accordance with some embodiments.

FIG. 12 illustrates a flowchart of a method 1200 of facilitating dynamic entity association, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

The detailed description that follows may provide a framework for describing computer-implemented systems, artificial intelligence systems, distributed learning infrastructures, data processing pipelines, and hardware and software arrangements suitable for implementing embodiments shown in the drawings. Terms such as processing, computing, determining, or generating refer to actions performed by computing systems or electronic devices that manipulate data represented as physical signals, stored values, or encoded information within registers, memory structures, and storage devices.

The present disclosure contemplates implementations involving artificial intelligence, machine learning, distributed computation, and computer-implemented systems operating upon data represented as physical electronic or optical signals. Descriptions of processing, analyzing, determining, transforming, encoding, decoding, generating, inferring, synthesizing, modifying, storing, retrieving, ranking, filtering, validating, classifying, or otherwise manipulating information are to be understood as referring to the actions of computing systems, electronic devices, or computational circuits that manipulate such signals in memory elements, registers, buffers, or storage media. These operations may be performed by general-purpose processors, specialized processors, machine learning accelerators, or combinations thereof.

The disclosure contemplates implementations in which artificial intelligence systems perform perception, synthesis, inference, prediction, or generation of information using models whose configurations may evolve based on training, feedback, or adaptive learning processes. A model may initially be configured with a set of parameters and architectural structures that define its behavior, and this configuration may change automatically as the model encounters training inputs, validation data, reference data, or instructor-provided feedback. A machine learning model may modify its internal state through optimization techniques, gradient updates, reinforcement signals, vector transformations, attention mechanisms, latent variable adjustments, embedding refinements, or other learning operations executed electronically. Such modifications may occur over extended cycles, partial cycles, or continual learning sequences without explicit intervention by a human.

The disclosure contemplates systems involving data ingestion pipelines that gather input from sources including but not limited to sensor signals, event streams, text data, image data, audio data, video data, structured and unstructured repositories, application logs, telemetric feeds, network services, or human-generated content. Ingestion functions may include filtering, normalization, augmentation, segmentation, batching, tokenization, windowing, compression, encryption, decryption, hashing, deduplication, contextualization, and mapping to internal formats. Intermediate components may transform this data into derived representations, including embeddings, latent encodings, feature tensors, multi-modal joint representations, or contextual vectors suitable for use by downstream modeling engines. These transformations may be performed using neural networks, statistical encoders, dimensionality-reduction algorithms, or hybrid computational modules.

The disclosure contemplates machine learning systems that may employ advanced architectures such as transformer networks, encoder-decoder stacks, mixture-of-experts structures, diffusion models, recurrent networks, convolutional hierarchies, attention-based models, retrieval-augmented architectures, cross-modal alignment engines, graph neural networks, probabilistic models, auto-encoding frameworks, or hybrid symbolic-neural systems. Such models may implement deep layers configured to perform operations including attention calculations, feed-forward projections, gating operations, positional encoding, normalization steps, multi-head routing, sequential decoding, or latent pathway selection. Multi-modal systems may combine textual, visual, auditory, sensory, or structured inputs within joint representational spaces. Embeddings may be learned from large corpora or multi-modal datasets and may encode semantic, syntactic, structural, temporal, spatial, or contextual relationships across modalities. These embeddings may be dynamically updated as the system encounters new information, thereby improving consistency, expressiveness, or alignment with real-world contexts.

The disclosure contemplates training processes that may involve supervised learning, unsupervised learning, semi-supervised learning, self-supervised learning, reinforcement learning, preference optimization, curriculum-based learning, active learning, or continual learning. Training operations may include forward passes through the model, backward propagation of gradients, update steps using optimization algorithms, adaptive learning-rate scheduling, regularization steps, loss-function evaluation, and checkpointing of intermediate states. Training datasets may include real-world data, synthetic data, simulated data, augmented data, or mixtures thereof. Validation procedures may evaluate performance metrics, generalization behavior, safety constraints, or compliance with domain-specific criteria. In some implementations, refinement cycles may incorporate human-in-the-loop interventions, reward model shaping, safety evaluator feedback, or guided corrections.

The disclosure contemplates distributed or federated execution in which computation is partitioned across multiple hardware devices, regions, or clusters. Certain operations may occur at edge devices for low latency, while others may be delegated to remote servers, cloud clusters, datacenters, or specialized compute fabrics. Components may communicate over wired or wireless networks supporting data exchange, synchronization, replication, or model-state updates. Distributed learning processes may synchronize gradients, coordinate model versions, merge updates across shards, or exchange activation values within parallel training regimes. Distributed inference may involve routing requests across replicas, balancing load through orchestration layers, or selecting model pathways dynamically. Network connections may include encryption, authentication, secure session management, or routing protocols appropriate for maintaining privacy, integrity, or availability.

The disclosure contemplates orchestration layers capable of managing complex workflows involving model invocation, tool invocation, external data retrieval, decision routing, fallback selection, multi-model aggregation, post-processing evaluation, or safety governance. Orchestration environments may evaluate contextual signals, metadata, user characteristics, or policy constraints to determine which models, subsystems, or computational branches should be executed. Such environments may dynamically alter execution pathways based on estimated performance, resource availability, model confidence, safety risk, or real-time system health. Post-processing components may evaluate generated outputs for compliance with content policies, statutory requirements, operational constraints, or domain-specific decision rules.

The disclosure contemplates safety-oriented components that evaluate model outputs or intermediate representations for consistency with safety criteria, quality thresholds, regulatory considerations, factual accuracy constraints, domain restrictions, or alignment requirements. Safety modules may employ auxiliary models, discriminators, rule sets, statistical detectors, confidence estimators, or hybrid evaluators to identify undesirable outputs. These modules may trigger remediation actions including output modification, output rejection, re-routing through alternate inference pathways, invocation of corrective models, or escalation for human review. Safety processes may incorporate real-time validation, contextual scoring, adversarial robustness analysis, anomaly detection, or controlled generation constraints.

The disclosure contemplates governance structures including policy managers, audit loggers, compliance trackers, version controllers, and provenance systems that associate model outputs with contextual metadata, historical signals, update events, training sources, or safety evaluations. Systems may maintain lineage records documenting which model version, configuration state, or training dataset contributed to an outcome. Governance modules may ensure that system behavior aligns with formal requirements such as fairness principles, legal obligations, industry standards, or institutional guidelines.

The disclosure contemplates storage and memory systems capable of storing model parameters, datasets, embeddings, logs, metrics, checkpoints, execution traces, and auxiliary information used to configure or interpret model behavior. These storage systems may include magnetic media, semiconductor memory, optical media, solid-state arrays, distributed storage fabrics, or hybrid memory hierarchies. Storage media may contain instructions, configurations, or data structures that, when accessed by a computing device, configure that device to carry out the operations described herein. Such media may include executables, bytecode, machine code, firmware, microcode, program modules, configuration files, architectural descriptors, or schema definitions.

The disclosure contemplates user interfaces that permit human operators to view model outputs, initiate tasks, modify configurations, inspect metrics, interact with logs, evaluate safety signals, or guide system adaptation. Interfaces may be multimodal and may support textual input, speech commands, visual interaction, gesture control, or programmatic invocation through APIs. Administrative interfaces may allow for reviewing system performance, tuning operational thresholds, enabling or disabling features, monitoring resource use, examining generated content, or initiating refinement workflows.

The disclosure contemplates systems in which instructions are executed entirely on a single device, partially on multiple devices, or cooperatively across remote and local environments. Code may execute directly on hardware, within firmware, inside virtual machines, inside containers, or through any combination of software and hardware interactions. Computational instructions may be stored locally, transferred via communication networks, or streamed from remote systems. Implementations may involve software executing on general-purpose processors, specialized logic circuits performing equivalent functions, or hybrid mechanisms that combine hardware acceleration with software guidance.

Interpretation of terms in this disclosure is governed by principles commonly applied by persons of ordinary skill in the relevant field. Technical and scientific terms used herein should be understood in a manner consistent with their usage in the field of artificial intelligence, machine learning, computing, networking, data storage, or any related discipline. Terms describing functionality should not be interpreted as strictly structural unless explicitly stated. Phrases such as configured to, adapted to, operable to, or capable of indicate permissible functionality rather than structural limitations. Terms such as a or an encompass one or more unless clearly contradicted by context. Terms joined by or should be interpreted as inclusive, and terms joined by and should be interpreted as collective.

The description set forth herein provides a broad and flexible framework intended to support a wide range of computer-implemented, machine-learning-enabled, distributed, and multimodal embodiments. Variations may include reallocation of tasks, substitution of algorithms, reconfiguration of models, changes to pipeline ordering, or adoption of alternate hardware. No combination or arrangement mentioned herein should be regarded as required unless explicitly stated. The scope of protection is established by the claims, interpreted in light of this description.

The present disclosure contemplates implementations that employ advanced mathematical frameworks characteristic of modern artificial intelligence systems. Machine learning models may be conceptualized as parameterized functions that map elements of an input space to elements of an output space. Such a function may be defined over real-valued, complex-valued, vector-valued, tensor-valued, or mixed-modal domains. The model may implement successive transformations applied to an ordered set of input vectors using compositions of linear operators, nonlinear activations, attention functions, normalization operations, and dimensional projections.

Model parameters may be represented as ordered collections of real-valued scalars arranged into structures such as matrices, tensors, kernels, filters, or embeddings. These parameters may be optimized by minimizing a loss functional defined over an expected distribution of input-output pairs. The optimization process may involve computing gradients of the loss functional with respect to each model parameter, followed by an update step that serves to reduce the value of the loss functional. Gradient computation may use automatic differentiation frameworks that symbolically or numerically propagate partial derivatives backward through a computational graph.

Attention mechanisms may employ a similarity measure between projected query vectors and projected key vectors. This similarity measure may yield a weight distribution over contextual elements. The weighted combination of projected value vectors may form an attention output that is subsequently transformed through additional layers. Multiple independent attention heads may be aggregated to capture heterogeneous relationships within the input domain. Cross-attention mechanisms may operate similarly but with distinct source and target sequences.

Normalization steps may rescale intermediate representations using learned scaling and shifting coefficients. Activation functions may introduce nonlinearity by applying element-wise transformations selected to ensure differentiability and expressive capacity. Residual pathways may combine transformed and untransformed representations to facilitate stable gradient propagation under deep compositions. Positional encodings or structural embeddings may inject ordering, spatial, temporal, or relational information into otherwise permutation-invariant architectures.

Multi-modal models may operate over domains that combine text, image, audio, video, sensor, or structured signals. These domains may be embedded into a common vector space through learned projection operators. Joint training processes may enforce alignment constraints that minimize representational divergence between modalities while preserving intra-modal semantics.

Diffusion frameworks may model data generation as the reversal of a stochastic corruption process. A forward process may incrementally add noise to data samples, while a learned reverse process may approximate the time-reversed conditional probability distribution. The reverse process may be parameterized by a neural network trained to denoise intermediate states. Continuous-time formulations may model this process using stochastic differential equations whose drift and diffusion terms are learned through score-matching or related techniques.

Reinforcement-based procedures may model learning as an optimization of expected reward under a policy function. The policy may produce distributions over actions given a latent or explicit representation of the environment state. Policy gradients may be estimated from sampled trajectories, and advantage estimators may reduce variance of such gradients. Value functions may approximate the expected cumulative reward, and these approximations may be updated through temporal-difference learning.

Generative models may be expressed in probabilistic terms as joint or conditional distributions parameterized by neural architectures. Such models may perform sampling by iteratively drawing latent variables from a learned distribution and transforming those variables into output space. Variational models may introduce auxiliary latent variables whose posterior distributions are approximated through recognition functions that optimize an evidence-bound objective.

Matrix decompositions, spectral analysis, manifold learning, kernel operators, and other mathematical constructs may be incorporated to improve expressiveness, stability, or computational efficiency. Training may involve sophisticated schedulers, trust-region constraints, adaptive learning-rate schemes, gradient-norm clipping, regularization penalties, entropy maximization, attention masking, or mixed-precision arithmetic.

All such mathematical constructs are conceptual, descriptive, and non-limiting. The disclosure encompasses any differentiable or non-differentiable optimization method, any discrete or continuous learning paradigm, and any representational transformation that may be understood by a person of ordinary skill in the field.

Further, the disclosure provides a computing environment which may include a combination of client devices, servers, distributed computing clusters, databases, external data sources, network nodes, and interface endpoints. Such an environment may support artificial intelligence workloads including perception, synthesis, inference, prediction, and generation, using hardware and software foundations designed for high-throughput and low-latency operation. Embodiments may involve the coordinated use of multiple machine learning models, whose configurations may evolve over time as they learn from training, validation, reference, or feedback data. Models may adjust their internal parameters through supervised, unsupervised, or reinforcement-based processes, allowing automatic electronic improvements to their performance based on input data and observed outcomes.

Further, the disclosure provides a computing device which may include processing units, memory elements, storage devices, system buses, high-speed controllers, low-speed controllers, and expansion interfaces. Processors may include general-purpose units, multi-core processors, vector processors, digital signal processors, tensor accelerators, neural accelerators, graphics engines, or various kinds of specialized integrated circuits including FPGAs, ASICs, ASSPs, SoCs, and CPLDs. A device may include system memory composed of volatile or non-volatile components such as RAM, DRAM, flash memory, ROM, or phase-change memory. The storage subsystem may include solid-state drives, magnetic disks, optical media, arrays of storage devices, and network-attached storage resources. Input and output mechanisms may include microphones, displays, keyboards, pointing devices, biometric sensors, gesture or touch interfaces, and actuators suitable for multimodal interaction with a user.

Further, the disclosure provides a machine-learning architecture which may include engines or modules such as a data input engine, data retrieval engine, data transform engine, featurization engine, modeling engine, generative engine, validation engine, feedback engine, and refinement engine. A data input pipeline may obtain structured or unstructured information from various sources, transform the information into model-compatible forms, and store such transformed data in memory or storage accessible to downstream components. A modeling engine may perform tasks such as model training, re-configuration, validation, and testing, executing iterative processes across multiple cycles or passes through training data. A predictive or generative engine may construct outputs based on intermediate representations, learned embeddings, or latent encodings generated by layers such as encoder-decoder structures, attention mechanisms, or multi-layer transformer architectures. Embeddings may represent discrete entities such as words, documents, or images as continuous vectors in high-dimensional spaces, capturing semantic or structural relationships useful for downstream tasks.

Further, the disclosure may provide a distributed or cloud-based operation may include multiple physical or virtual instances of computing devices, distributed across data centers or network boundaries. Functions may be partitioned across machines to achieve parallelism, redundancy, fault tolerance, or improved throughput. Distributed systems may use load balancing mechanisms to maintain stable processing, memory, or bandwidth utilization across clusters and avoid overload conditions. Such deployments may require communication over wired or wireless networks that implement a variety of protocols including HTTP, HTTPS, MQTT, CoAP, or any other suitable communication framework. Communication channels may include local networks, wide-area networks, personal-area networks, or global communication systems, potentially utilizing secure encrypted sessions such as SSL-based channels.

Further, the disclosure may provide an algorithm, process, or flow diagram which may include operations that may occur in sequences, reversed orders, concurrently, or in partially overlapping timelines, depending on the implementation. Blocks representing actions in a flowchart may correspond to program modules, instruction sequences, or hardware logic capable of performing the specified acts. Such operations may manipulate physical quantities such as electrical or magnetic signals stored or transferred among memory units, registers, storage devices, or communication media. Flow diagrams may be realized through software running on general-purpose processors, through dedicated hardware circuits, or through combinations of both.

Further, the disclosure may provide memory, storage, or programmatic constructs which may include program instructions encoded on computer-readable media including electronic, magnetic, optical, electromagnetic, semiconductor, or other tangible media. Examples include RAM, ROM, EEPROM, flash memory, magnetic disks, optical disks, and mechanical encoded structures such as punch cards or raised-pattern media. Such storage media may store instructions that, when executed, configure the memory and therefore configure the computing device itself, causing the device to perform functions described in association with the drawings.

Further, the disclosure may provide a user interface which may include graphical displays, dashboards, selection controls, input fields, monitoring elements, or multimodal interaction surfaces, allowing users to interact with computing systems in speech, touch, gesture, or other modalities. Such interfaces may be presented through client devices, server applications, or remote access platforms and may support visualization of model behavior, systems performance, or configuration parameters.

Further, described features may be combined, rearranged, omitted, or substituted without departing from the principles disclosed. Variations may involve distributing functionality across devices, merging components, implementing features in hardware rather than software, or employing alternative communication protocols. Many such variations and modifications are intended to fall within the scope of the disclosure as understood by persons skilled in the art.

The detailed description of the drawings therefore provides a foundation for describing technical, architectural, and operational aspects of embodiments, while allowing broad flexibility in how such embodiments may be implemented in practice. The scope of such embodiments is governed by the claims rather than the illustrative content of the drawings.

In some embodiments, a system consistent with this disclosure includes one or more client devices, one or more servers, and one or more data stores coupled by one or more networks. The client devices can include, without limitation, mobile phones, tablet computers, laptop or desktop computers, wearable devices, smart displays, vehicles, robots, or other computing platforms equipped with data processing hardware and memory hardware. The servers can include data servers, application servers, web servers, proxy servers, or cloud computing services that provide shared processing, storage, and networking resources. The data stores can include databases, object stores, file systems, or other repositories that persist configuration data, training data, logs, model artifacts, and other information.

The networks can include public and private networks, such as local area networks, wide area networks, and cloud networks, using wired or wireless communication links. The networks can provide routing, addressing, access control, encryption, and related functionality using standard or proprietary protocols.

Each computing device, whether a client device or a server, can include one or more processors, system memory, persistent storage, communication interfaces, and input or output devices. The processors can include general purpose central processing units, graphics processing units, digital signal processors, microcontrollers, application specific integrated circuits, field programmable gate arrays, or other programmable or fixed function processing elements configured to execute instructions or perform logic operations. The memory can include volatile and non-volatile storage, such as random access memory and read only memory. The persistent storage can include solid state drives, magnetic disks, optical media, or other non-transitory computer readable media.

Program code executed by the processors can include operating systems, device drivers, libraries, and application programs, including components that implement portions of the methods described herein. Program code and data can be stored on computer readable media and loaded into memory by standard mechanisms, such as boot loaders, installation programs, or update services.

Input devices can include keyboards, pointing devices, microphones, cameras, touch sensitive surfaces, biometric sensors, and other sensors. Output devices can include displays, speakers, haptic devices, printers, and other actuators. Some devices can support multimodal interaction, allowing combined or sequential input and output through various modalities.

For purposes of this disclosure, artificial intelligence systems may include arrangements of software and hardware that perform tasks such as perception, prediction, planning, or generation based on input data. These systems can employ one or more models, such as statistical models, neural networks, decision trees, or other machine learning models. As used herein, a “model” can refer to a parameterized function, an ensemble of such functions, or a collection of cooperating components that process data and produce outputs.

In some embodiments, the system includes a data input engine that obtains data from one or more sources, such as application logs, sensor streams, structured databases, and unstructured content. The data input engine can retrieve, filter, aggregate, or transform the data into feature representations suitable for model consumption. Data sources can include training data, validation data, and reference data used to evaluate and calibrate model behavior.

A modeling engine can manage one or more training processes for one or more models. The modeling engine can select model architectures, initialize parameters, and apply training algorithms such as supervised learning, semi supervised learning, unsupervised learning, reinforcement learning, or combinations thereof. The modeling engine can also manage hyperparameters, training schedules, and evaluation procedures across epochs or passes through the data.

The system can include a generative response engine or inference engine that receives prompts or other inputs and generates outputs using one or more models. For example, a natural language interface can receive a text prompt, embed or otherwise encode the prompt, process the encoded prompt using a transformer based model or other sequence model, and generate a sequence of tokens that are decoded into an output. The engine can generate multiple candidate outputs and apply validation or ranking logic to select a final result according to quality, safety, or relevance criteria.

A feedback engine can collect explicit or implicit feedback signals, such as user ratings, corrective edits, or outcome metrics derived from downstream tasks. A refinement engine can use such feedback to adjust model parameters, routing logic, or policies, for example by performing additional training steps, updating reward models, or modifying configuration parameters.

In certain embodiments, the disclosed techniques are applied to platforms that include sensors and actuators, such as vehicles, robots, or other machines. The platform can include a processor system that receives signals from cameras, lidar units, radar units, inertial sensors, and other devices, and produces control outputs for steering, propulsion, braking, or other actuators. Sensor data can be captured at various sampling rates and processed by perception models to detect and track objects and infer scene attributes.

Planning and control components can receive outputs from perception models along with route information, traffic rules, and high level goals. These components can generate trajectories or control commands, optionally using reinforcement learned policies, optimization based planners, or hybrid systems. Connections to backend services can permit off board processing, fleet level learning, or remote supervision where appropriate, while on board components can maintain safe operation in the presence of network latency or failures.

The systems described herein can be implemented using centralized, decentralized, or hybrid arrangements. For instance, models may be deployed in cloud environments, on edge devices, or across both, depending on requirements such as latency, privacy, cost, and reliability. Load balancing and resource management components can distribute processing across devices or data centers and can provide elasticity to accommodate changing workloads.

Certain embodiments may expose functionality through application programming interfaces, software development kits, or graphical user interfaces. Client applications can submit requests to backend services, which can apply authentication, authorization, logging, and policy enforcement before invoking models or tools and returning results.

The systems and methods disclosed herein can be implemented in hardware, software, firmware, or any combination thereof. In some embodiments, operations are carried out by one or more processors executing program instructions stored on one or more non transitory computer readable media. Such media can include, without limitation, semiconductor memory, magnetic storage, optical storage, and combinations thereof. Program instructions, when executed by the processors, cause the processors to perform the operations described herein.

Instructions can be delivered to computing devices in various ways, such as pre installation, physical distribution of media, or transmission over networks. Instructions received over a network can be stored in memory or persistent storage and then executed by one or more processors. Dedicated hardware logic, such as application specific integrated circuits or field programmable gate arrays, can be used alone or in combination with software to implement certain functionality.

Any methods described in connection with embodiments of the present disclosure can be represented as one or more flow diagrams or state diagrams. Blocks in such diagrams can correspond to modules, components, operations, or code segments that implement the associated functionality. Blocks can be reordered, combined, executed concurrently, or omitted according to implementation specific considerations, unless a particular ordering is required by the claims.

Examples and embodiments described herein illustrate, rather than limit, the claimed subject matter. Certain features have been described in connection with particular embodiments for clarity, but other embodiments can include such features in different combinations. Features described in separate embodiments can be combined, and features described in a single embodiment can be separated, unless such combinations or separations are inconsistent with the claims. The scope of the disclosure is defined by the claims and their equivalents.

### Overview

The present disclosure relates to the field of sports analytics and multi-entity tracking. Further, the present disclosure describes a system for dynamically associating participants and objects in sports settings. The system may employ advanced approaches, including neural network-based object detection, trajectory prediction, occlusion handling, and global association optimization across multiple frames. The methods and system disclosed herein may create composite objects, such as a player with a ball, and identify key participants, including shooters, goalkeepers, or ball carriers, using advanced spatial and temporal models to provide real-time insights for performance analysis. As sports performance demands more granular analysis, there is a growing need for intelligent tracking systems that may create higher-level associations between players and objects, identify primary participants, and adapt dynamically to complex scenarios, such as crowded fields or multi-participant sports events.

Current sports tracking systems face limitations when tracking multiple participants and objects in real time, especially in crowded, fast-moving environments. While existing tracking technologies may identify individual players or objects, the existing tracking technologies may struggle to dynamically associate entities to recognize key participants or evaluate specific events (e.g., identifying the shooter or ball holder). Furthermore, existing systems typically rely on simple proximity or overlap detection, failing to maintain robust associations through occlusions, complex group interactions, and rapid movements.

Further, the present disclosure describes a multi-entity tracking system with dynamic player-entity association, enabling precise identification and performance evaluation of key participants across various sports. The system may create composite objects like a player with a ball by dynamically associating participants and sports-related objects through advanced tracking models. The method and system may integrate spatial and temporal data streams to ensure seamless tracking and adaptive feedback, even in crowded or fast-changing environments.

Further, the composite object data structure includes player ID+object ID+association confidence+time interval. Further, the composite object updates over time and persists through occlusions. Further, the composite object triggers role labeling (shooter/ball carrier/goalkeeper).

Further, the identifying of the composite object may be followed by one or more of role classification based on sport-aware spatial zones (e.g., goalkeeper in defensive zone), possession/control inference from motion correlation, and identifying an action/interaction signatures (e.g., release or impact events).

Further, the disclosed method/system may determine the association includes computing an association confidence score; the association may be accepted only if the association confidence score exceeds a threshold. Further, feedback generation may be gated based on the association confidence score.

Further, the association may be recognized only if the association persists for at least a minimum number of frames or a minimum time duration. Further, the association validator smooths association likelihoods over time to suppress transient spikes.

Further, the association may be maintained through an occlusion event using predicted trajectories and re-identification. Further, the tracking includes re-identification across occlusion using appearance embeddings and motion models. Further, the association may be determined based on trajectory correlation between player motion and object motion.

Further, the association represents control of the object by the player as determined from the alignment of velocity/acceleration vectors. Further, the association represents physical contact inferred from kinematic features over a time interval.

Further, the disclosed method may include generating a composite object record comprising (i) a player identifier, (ii) a sport object identifier, (iii) a time interval, and (iv) an association confidence.

Further, the composite object record is updated over time as association likelihood changes. Further, the disclosed method may include detecting a handoff event in which the sport object association changes from a first player to a second player. Further, the handoff event may be detected based on changes in association confidence over time.

Further, the disclosed method may include classifying a primary participant role selected from: shooter, ball carrier, or goalkeeper. Further, the role classification is determined using sport-aware spatial zones (e.g., defensive zone) and temporal behavior patterns.

Further, the primary participant may be determined using a weighted combination of: association confidence, temporal persistence, spatial zone likelihood, and motion correlation.

Further, the sports object is selected from: ball, puck, stick, club. Further, the association algorithms are parameterized by sport type and incorporate sport-specific rules.

Further, the composite object record and association events are stored as metadata for downstream retrieval, overlays, and performance evaluation.

Further, the system may provide adaptive feedback mechanisms, allowing athletes and coaches to receive insights via video overlays, reports, or real-time collaboration tools. Further, the disclosed framework may ensure robust, real-time performance evaluation across sports scenarios such as basketball, football, and hockey.

The following are the key features of the disclosed system and method:

### 1. Method for Multi-Entity Tracking and Composite Object Creation:

A method may track multiple participants and sports-related objects across video frames, dynamically creating composite objects such as player-with-ball to enhance situational awareness and performance evaluation.

### 2. System for Dynamic Player-Entity Association and Identification of Primary Participants:

A system may determine primary participants such as shooters, goalkeepers, or ball carriers using advanced spatial and temporal data models to adapt to dynamic sports environments.

### 3. Adaptive Feedback Mechanism Based on Composite Object and Primary Participant Evaluation:

A feedback system may dynamically evaluate primary participants and composite objects, providing real-time insights tailored to situational context and performance criteria.

### 4. Integration of Spatial and Temporal Data Streams for Precision Tracking:

A system may integrate spatial and temporal data streams to dynamically track and evaluate participants and composite objects in real time. Further, the system may employ global association optimization across multiple frames (similar to DeepSORT approaches) to maintain consistent entity associations through occlusions and complex interactions. The robust associations may enable reliable identification of primary participants such as shooters, goalkeepers, or ball carriers, even in dynamic sports environments.

### 5. Dynamic Identification and Evaluation Across Sports Scenarios:

A method may identify and evaluate primary participants across multiple sports, such as identifying the shooter in basketball, the goalkeeper in hockey, or the ball carrier in football, based on real-time tracking models.
Further, the system may adapt the system's association algorithms to sport-specific scenarios, employing specialized models for different types of player-object interactions, such as ball possession in basketball, puck control in hockey, or ball carrying in football. The specialized models may incorporate sport-specific rules and patterns to maintain accurate associations.

The following are the detailed descriptions of the key features:

### 1. Multi-Entity Tracking and Composite Object Creation

The system may use adaptive tracking algorithms to assign object IDs across video frames, enabling the system to track multiple participants and sports objects (e.g., players, balls, pucks). The system may dynamically create composite objects, such as a player with a ball, for enhanced situational awareness and performance evaluation.
For example, in basketball, the system may use player tracking and object detection to form player-with-ball composite objects. If multiple such objects exist (e.g., during individual training sessions), the system may identify the primary player based on proximity to the center of the frame or other configurable rules or advanced tracking and association algorithms.

### 2. Dynamic Player-Entity Association for Primary Participant Identification

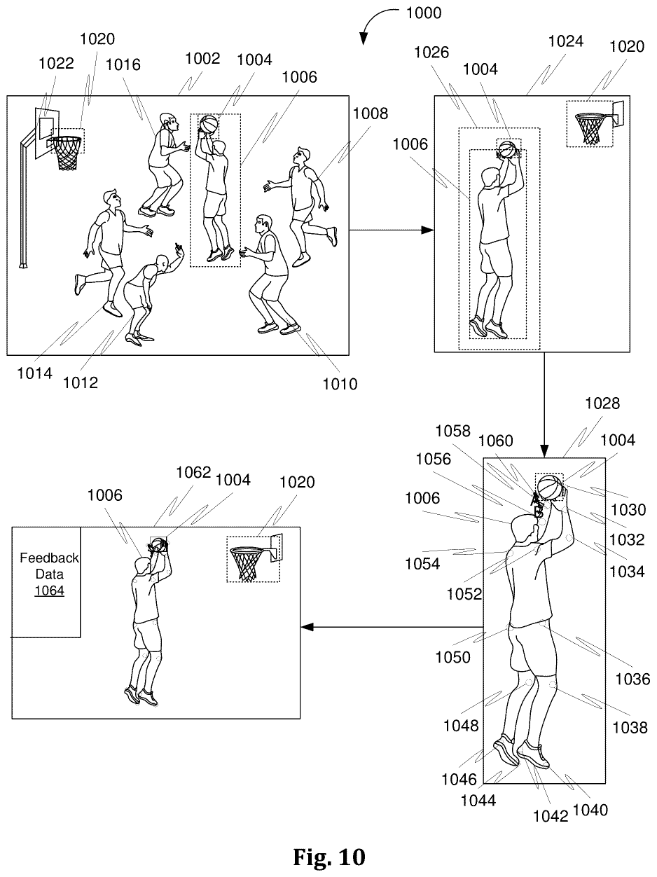

Dynamic Player-Entity Association may determine the primary participant for a given situation by leveraging both spatial configurations and temporal behavioral patterns. The system may employ sophisticated computer vision and tracking algorithms to maintain robust associations between players and sports objects.
The system may integrate neural network-based detection confidence scores, trajectory prediction, occlusion handling, and global optimization across multiple frames to maintain associations even in challenging scenarios with multiple overlapping players, partial observations, and complex group interactions.
The system may employ global association optimization across multiple frames (similar to DeepSORT approaches) to maintain consistent entity associations through occlusions and complex interactions. The robust associations enable reliable identification of primary participants such as shooters, goalkeepers, or ball carriers, even in dynamic sports environments. Examples include:
   Basketball: The method and system may identify the shooter by associating player tracking data with ball possession and motion during detected shot phases, such as transfer, pocket, and release.
   Football: The method and system may recognize the ball holder based on possession transitions and movement patterns.
   Hockey: The method and system may detect the goalkeeper using position-based tracking and spatial configurations within the defensive zone.
The dynamic association ensures that the system adapts to real-time conditions, even in crowded sports environments with multiple participants. The method of identifying and analyzing a player and a ball is illustrated in FIG. 10.

### 3. Adaptive Feedback Based on Composite Objects and Primary Participants

Once the primary participant is identified, the system evaluates the performance of the primary participant by applying sport-specific criteria to the composite objects and associated participants. Building upon the foundational association system, the platform may enable sophisticated performance analysis of correctly identified primary participants and the interactions with sports objects, providing context-aware insights and feedback.
The system may provide adaptive insights via several delivery mechanisms:
   Visual Overlays: The system may highlight key actions and performance metrics during video playback.
   Scorecards and Reports: The system may deliver via web and mobile applications for detailed post-analysis.
   WebRTC Collaboration: The system may enable real-time communication and feedback between coaches and athletes.
The adaptive feedback ensures that performance evaluations are precise and tailored to the specific sports scenario.

### 4. Integration of Spatial and Temporal Data for Precision Tracking

The system may integrate spatial and temporal data streams to dynamically track participants and composite objects, ensuring seamless identification and performance evaluation across various sports scenarios. Examples include:
   Basketball: The method and system may evaluate the shooter's body alignment and release timing to improve shot mechanics.
   Football: The method and system may track the ball carrier's movements to assess agility and decision-making under pressure.
   Hockey: The method and system may monitor the goalkeeper's positioning and responses for enhanced performance feedback.
The integration may ensure robust, real-time performance tracking, even in fast-changing, multi-entity environments.

The present disclosure describes a multi-entity tracking system with Dynamic Player-Entity Association to identify and evaluate primary participants across sports. By creating composite objects such as a player with a ball and applying spatial and temporal data models, the system provides real-time insights and adaptive feedback. The platform may identify key participants, such as shooters, goalkeepers, or ball carriers, and supports performance improvement across sports like basketball, football, and hockey. The comprehensive framework may ensure that performance tracking is precise, adaptive, and context-aware, even in complex, multi-entity environments.

Further, the present disclosure relates to systems and methods for dynamic player-entity association and performance analysis in sports environments. The disclosure generally introduces multiple technical features that, either individually or in combination, may provide inherent and additional improvements to computer vision systems, multi-entity tracking systems, real-time analytics frameworks, and spatiotemporal inference technologies.

In some embodiments, the system may include a technical feature directed to the generation of a composite object data structure that represents an association between a player and a sport object derived from a content stream. The technical problem addressed by the generation of a composite object data structure concerns the inability of conventional tracking systems to maintain a persistent and semantically meaningful link between a player and an object in crowded or fast-changing environments. Traditional approaches rely heavily on frame-wise proximity rules that are susceptible to failure during occlusions, rapid object transfer, and intertwined motion paths.

In some embodiments, the composite object data structure may be generated using a probabilistic fusion of object detection scores, predicted movement vectors, relative kinematic behavior, and temporal association windows. In some embodiments, the processing device may implement a neural association module trained on multi-view sports datasets such that the system may identify subtle but reliable behavioral correlations between a player's posture transition and ball possession.

In some embodiments, the system may implement the above feature through a temporal-attention model that weighs recent frames more heavily during rapid possession changes. Further, the above feature may improve the technology of multi-entity tracking by providing a higher-order object representation that cannot be produced by conventional bounding-box tracking pipelines.

In some embodiments, the system may include an occlusion-resilient association mechanism that may maintain the integrity of the composite object data even when the player-or-object visibility is degraded. The technical problem addressed by the occlusion-resilient association mechanism concerns the breakdown of association models in scenarios where players overlap physically, obstruct each other, or move through high-density regions of play. Traditional motion-based trackers may lose identity once a bounding box becomes partially obscured.

In some embodiments, the occlusion-resilient mechanism may include a predictive state estimator that extrapolates player pose and object position through a learned biomechanical model. In some embodiments, a graph neural network may be used to infer missing player-node states using information propagated through neighboring graph nodes representing nearby players. In some embodiments, the system may use depth estimation derived from monocular depth networks to determine which player is likely in the foreground or background, thereby resolving occlusion ambiguities. Further, the occlusion-resilient mechanism feature may improve the underlying computer vision technology by enabling continuity of association under visual degradation.

In some embodiments, the system may include a temporal pattern interpretation unit that evaluates player behavior sequences to enhance the accuracy of primary participant identification. The technical problem addressed arises because instantaneous frame-wise evaluation fails to recognize multi-frame contextual patterns, such as shot preparation in basketball or puck control transitions in hockey. In some embodiments, the temporal analysis may include a recurrent neural network trained on movement phases labeled by expert annotators, allowing inference of latent action states even when the sport object is not clearly visible.

In some embodiments, the system may use phase-segmented temporal windows to capture micro-behaviors such as transfer, pocket formation, and release in shooting motions. In some embodiments, the system may further incorporate biomechanically constrained models that enforce physically plausible joint trajectories. The temporal pattern interpretation unit feature may improve the technology of action recognition by providing a structured temporal segmentation mechanism.

In some embodiments, the system may include a spatial configuration evaluation engine that identifies relationships between player positions and canonical positional regions associated with a particular sport. The technical problem addressed is that existing tracking technologies do not incorporate rule-based spatial semantics; for example, many systems may not infer which player is likely to be a goalkeeper solely from the relative position in the defensive zone.

In some embodiments, the spatial configuration evaluation engine may incorporate a learned spatial probability map that associates field coordinates with expected player roles. In some embodiments, the system may create dynamic heatmaps that evolve through a match, allowing recognition of atypical but valid role shifts. In some embodiments, the spatial evaluation unit may merge field-centric coordinates and screen-centric coordinates through homography transformations to maintain spatial accuracy across camera angles. The spatial configuration evaluation engine feature may improve spatial reasoning technologies by introducing sport-aware spatial inference capabilities.

In some embodiments, the system may include a trajectory-correlation component that determines whether the movement of the player and the sport object adheres to expected joint-motion patterns indicative of possession or interaction. The technical problem addressed is that naive distance-based tracking may not distinguish between a player moving near a ball and a player actively controlling the ball. In some embodiments, the trajectory-correlation component may compare direction vectors, acceleration signatures, curvature patterns, and velocity alignment metrics between the player and the sport object.

In some embodiments, the system may implement trajectory-prediction networks that project short-term motion paths and use deviation scoring to determine whether the object appears to respond to the player's motion. The trajectory-correlation component feature may improve trajectory analysis technologies by integrating joint-motion correlation mechanisms.

In some embodiments, the system may include an automatic key-action identification capability that uses composite object data to detect meaningful events within a sport sequence. The technical problem addressed involves the difficulty of automatically detecting contextually significant actions such as shots, passes, or object releases without predefined sensors or manual labeling. In some embodiments, the key-action identification may be implemented using an action-boundary detector that identifies points where composite object semantics change abruptly. In some embodiments, a movement-signature classifier may detect high-acceleration phases correlated with object release. The automatic key-action identification capability feature may improve real-time sports analytics technologies by enabling automated identification of event boundaries.

In some embodiments, the system may include a performance metric generator that produces parameterized performance attributes for the primary participant using composite object data and spatiotemporal information. The technical problem addressed is the absence of automated analytics capable of extracting quantitative metrics such as shooting mechanics, release timing, or goalkeeper responsiveness directly from video frames. In some embodiments, the metric generator may compute kinematic features using estimated joint locations and object trajectory arcs.

In some embodiments, the system may calculate biomechanical parameters such as release angle deviation or body alignment offsets. The performance metric generator feature may improve sports biomechanics analysis technologies by automating the extraction of performance-critical parameters.

In some embodiments, the system may include a reference-metric comparison engine that analyzes the primary participant's performance metrics against stored baseline metrics. The technical problem addressed is the lack of dynamic, context-aware evaluation frameworks in existing systems, which typically rely on manual or subjective coach assessments. In some embodiments, the comparison engine may retrieve a reference metric stored for a given skill, role, or player archetype and compute deviation vectors or performance deltas. In some embodiments, the system may dynamically adjust comparison thresholds based on historical player performance trends. The reference-metric comparison engine feature may improve adaptive evaluation technologies by introducing automated benchmarking.

In some embodiments, the system may include a time-interval association validator that ensures that a player-object association persists for a minimum duration before being recognized as meaningful. The technical problem addressed concerns premature or incorrect association spikes that arise during chaotic play, where a ball may momentarily pass near multiple players. In some embodiments, the validator may compute frame-to-frame association likelihoods and enforce temporal coherence through a persistence threshold. In some embodiments, probabilistic smoothing may be used to eliminate noise. The time-interval association validator feature may improve multi-entity temporal consistency technologies.

In some embodiments, the system may include a self-supervised representation learning module that automatically learns relational features between players and sport objects without requiring manual annotation. The technical problem addressed is the high cost and limited scalability of manually labeled sports datasets. In some embodiments, contrastive learning frameworks may be used to differentiate true player-object interactions from coincidental spatial proximities. In some embodiments, predictive coding may be used to infer latent action states. The self-supervised representation learning module feature may improve machine learning technologies for spatiotemporal video analysis.

In some embodiments, the system may include an adaptive camera-motion compensation mechanism that performs stabilization and parallax correction when the source content stream includes camera movement. The technical problem addressed concerns the degradation of tracking accuracy due to zooming, panning, or unstable camera mounts. In some embodiments, the system may estimate camera motion vectors using background optical flow and subtract these vectors from player and object movement signals. In some embodiments, homography mapping may be dynamically recalibrated. The adaptive camera-motion compensation mechanism feature may improve video stabilization and camera-motion compensation technologies.

In some embodiments, the system may include a multi-modal sensor fusion capability for integrating audio cues with video recognition to improve accuracy in determining key actions. The technical problem addressed is that certain critical sports actions (such as ball-to-rim impact or puck-stick contact) produce characteristic audio signatures that are ignored by purely visual systems. In some embodiments, the system may analyze short-term Fourier transforms of the audio stream to detect impact-signature spikes. In some embodiments, the system may fuse audio-action likelihood with visual cues to enhance event boundary detection. The multi-modal sensor fusion capability feature may improve multi-modal event-detection technologies.

In some embodiments, the system may include a real-time reinforcement learning optimizer that adjusts association parameters based on feedback from successful or failed associations. The technical problem addressed revolves around static, hand-tuned thresholds for association logic that cannot adapt to differences in camera angles, court layouts, or player-specific behaviors. In some embodiments, the system may modify spatial proximity thresholds, temporal persistence values, or trajectory-correlation weights during runtime. In some embodiments, the optimizer may reward long-term association stability. The real-time reinforcement learning optimizer feature may improve adaptive tracking model technologies.

In some embodiments, the system may include a cloud-distributed inference architecture that partitions the composite object generation, primary participant identification, and analytics computation across multiple nodes to achieve sub-second latency. The technical problem addressed is the computational burden of high-resolution video processing in real-time sports applications. In some embodiments, the system may deploy lightweight edge models at camera endpoints while offloading temporal aggregation to central servers. In some embodiments, GPU-accelerated inference nodes may be orchestrated through a load-balancing scheduler. The cloud-distributed inference architecture feature may improve distributed real-time inference technologies.

Further, the present disclosure describes a method of facilitating dynamic entity association.

Further, in some embodiments, the method may include configuring the at least one content source device for capturing the at least one physical activity from a plurality of capturing modalities having capturing characteristics that are disparate from one another. Further, the plurality of capturing modalities may include, by way of example and not limitation, imaging modalities having different spectral sensitivities, different viewpoints, different fields of view, different depth sensitivities, different frame rates, or different ranges.

Further, the receiving of the at least one content data from the at least one content source device may include initializing the at least one content source device for capturing the at least one physical activity from a first capturing modality of the plurality of capturing modalities. Further, an “instance” of initialization may correspond to at least one of (i) a timestamp generated by the at least one content source device, (ii) a frame index of the content stream, or (iii) a stream sequence number, such that subsequent operations are synchronized to the instance.

Further, the receiving of the at least one content data may include: (a) receiving a content stream corresponding to the first capturing modality beginning from the instance of the initializing. Further, the content stream may comprise a sequence of frames or samples, each associated with a timestamp, and may be transmitted using a streaming protocol in which the content stream includes at least one of a stream identifier, a modality identifier, and the timestamp.

Further, the receiving of the at least one content data may include: (b) analyzing the content stream corresponding to the first capturing modality beginning from the instance of the initializing using at least one machine learning model. Further, the at least one machine learning model may be executed by an inference engine implemented as software instructions executed by at least one processor, as firmware, as dedicated hardware (e.g., a neural processing unit), or as a combination thereof. Further, inputs to the at least one machine learning model may include at least a current frame and at least one of a prior frame, optical flow, keypoint heatmaps, segmentation masks, depth maps, motion vectors, or compressed-domain features extracted from the content stream.

Further, the receiving of the at least one content data may include: (c) predicting an instance of an entity occlusion event in the content stream corresponding to the first capturing modality based on an output of the at least one machine learning model satisfying at least one occlusion criterion. Further, an “entity occlusion event” may include at least one of partial occlusion, full occlusion, self-occlusion, inter-entity occlusion, or out-of-field-of-view loss, and the predicted instance may be represented as a future timestamp, a future frame index, or a future sequence number relative to a current frame.

Further, the receiving of the at least one content data may include: (d) determining a second capturing modality of the plurality of capturing modalities based on the predicting, wherein the second capturing modality may be selected as being suitable for overcoming the entity occlusion event. Further, “suitable” may be determined by a modality selection routine that evaluates at least one visibility criterion for at least one entity, wherein the visibility criterion may be computed based on at least one of estimated occluder location, estimated entity pose, line-of-sight feasibility, and field-of-view intersection for candidate modalities.

Further, the receiving of the at least one content data may include: (e) transmitting a control command to the at least one content source device based on the determining of the second capturing modality, wherein the control command causes the at least one content source device to change capturing from the first capturing modality to the second capturing modality at the instance of the entity occlusion event. Further, the control command may include at least one of a target modality identifier, an activation time (timestamp or frame index corresponding to the instance), and at least one capture parameter (e.g., exposure, gain, frame rate, resolution, focus, field of view, or viewpoint-control parameters).

Further, the receiving of the at least one content data may include: (f) receiving a content stream corresponding to the second capturing modality beginning from the instance of the entity occlusion event. Further, the content stream corresponding to the second capturing modality may include a modality identifier and timestamps aligned to the same time base as the content stream corresponding to the first capturing modality, such that the at least one content data is ordered in time across modality changes.

Further, the receiving of the at least one content data may include: (g) analyzing the content stream corresponding to the second capturing modality beginning from the instance of the entity occlusion event using the at least one machine learning model. Further, the at least one machine learning model may be configured to output occlusion-related indicators for a currently active modality, thereby enabling additional predicted occlusion instances during the duration.

Further, the receiving of the at least one content data may include: (h) repeating the predicting, the determining, the transmitting, the receiving, and the analyzing for each of one or more additional predicted instances of the entity occlusion event during a duration of the at least one physical activity. Further, the duration may correspond to a continuous time interval beginning at initialization and ending at termination of the physical activity's session or stream, and may be tracked using timestamps or sequence counters.

Further, the at least one content data may comprise the content stream corresponding to the first capturing modality and the content stream corresponding to the second capturing modality, and one or more additional content streams corresponding to one or more additional capturing modalities resulting from the repeating. Further, at any given time during the duration, the at least one content data may correspond to a currently active capturing modality, and across the duration, the at least one content data may comprise successive time-ordered segments associated with different capturing modalities.

Further, by predicting occlusion instances in advance and controlling capture modality changes at those instances, the method improves the operation of a real-time capture-and-analysis system by reducing occlusion-induced data loss, reducing interruptions in content streaming, and improving continuity of downstream entity association, thereby providing a technical solution to a technical problem in activity capture under occlusion.

Further, in some embodiments, the at least one occlusion criterion may comprise at least one of an occlusion probability output by the at least one machine learning model for at least one entity of the plurality of entities exceeding a probability threshold, a predicted overlap value output by the at least one machine learning model between a first bounding region associated with the at least one entity and a second bounding region associated with a different entity satisfying an overlap threshold, and a predicted keypoint visibility value output by the at least one machine learning model for the at least one entity falling below a visibility threshold.

Further, the occlusion probability may be a scalar value in a normalized range (e.g., 0 to 1), and the probability threshold may be selected based on at least one of a desired false positive rate, a desired false negative rate, or device-specific latency constraints. Further, the predicted overlap value may be computed using at least one overlap metric, including intersection-over-union, and the overlap threshold may be defined accordingly. Further, the predicted keypoint visibility value may correspond to a count or proportion of keypoints predicted as visible, or to an aggregate confidence score across keypoints.

Further, the predicting of the instance of the entity occlusion event may include predicting the instance of the entity occlusion event within a prediction time window preceding the instance of the entity occlusion event. Further, the prediction time window may be expressed as a time interval (e.g., milliseconds, 0.01-1 ms, 1-10 ms, 10-100 ms, etc.) or as a number of frames, and may be selected to provide sufficient time for command transmission and modality activation prior to the occlusion instance.

Further, the transmitting of the control command may be performed during the prediction time window such that the change capturing from the first capturing modality to the second capturing modality occurs at the instance of the entity occlusion event, thereby avoiding loss of critical content frames at the occlusion instance and maintaining temporal continuity of the at least one content data.

Further, in some embodiments, the plurality of capturing modalities may comprise at least one visible-light capturing modality and at least one non-visible-light capturing modality. Further, the at least one non-visible-light capturing modality may be selected from the group consisting of an infrared imaging modality, a depth-sensing modality, a radar modality, a lidar modality, an acoustic modality, and an inertial sensing modality.

Further, the first capturing modality may comprise the visible-light capturing modality, and the predicting of the instance of the entity occlusion event may be performed for the content stream corresponding to the visible-light capturing modality, such that occlusion-related indicators are generated for the currently active visible-light content stream.

Further, determining the second capturing modality as being suitable for overcoming the entity occlusion event may include selecting the second capturing modality from the at least one non-visible-light capturing modality when the output of the at least one machine learning model indicates that the entity occlusion event is associated with a line-of-sight obstruction in the visible-light capturing modality. Further, the line-of-sight obstruction may be indicated by at least one of an increase in predicted occluder presence, a predicted decrease in visible keypoints, or a predicted increase in bounding-region overlap. Further, in such cases, the content stream corresponding to the second capturing modality may comprise content captured using the selected non-visible-light capturing modality, thereby maintaining capture of the at least one physical activity despite reduced visible-light observability.

Further, the plurality of capturing modalities may further comprise a first camera capturing modality having a first viewpoint and a second camera capturing modality having a second viewpoint different from the first viewpoint, wherein the first camera capturing modality and the second camera capturing modality each comprise a visible-light capturing modality. Further, determining the second capturing modality as being suitable for overcoming the entity occlusion event may further include selecting the second capturing modality as the second camera capturing modality when the output of the at least one machine learning model indicates that the entity occlusion event is associated with viewpoint-dependent occlusion for the first camera capturing modality, such as occlusion by an intervening object relative to the first viewpoint but not relative to the second viewpoint.

Further, when the second capturing modality comprises the second camera capturing modality, the control command may further specify at least one viewpoint-control parameter comprising pan, tilt, or zoom. Further, the viewpoint-control parameter may be selected to maximize an estimated visibility of at least one entity at or near the predicted occlusion instance, based on the output of the at least one machine learning model and at least one camera field-of-view constraint.

Further, in some embodiments, after the receiving of the at least one content data, the method may include analyzing, using the processing device, the at least one content data using the at least one tracking algorithm to track the plurality of entities. Further, the tracking algorithm may be distinct from the at least one machine learning model used for predicting occlusion during receiving, and may include at least one multi-object tracking routine configured to associate entity detections across time-ordered frames of the at least one content data.

Further, the analyzing using the at least one tracking algorithm may include maintaining continuity of tracking for at least one entity of the plurality of entities across each change capturing resulting from the repeating. Further, maintaining continuity of tracking may include time-synchronizing a prior portion of the at least one content data comprising the content stream corresponding to a prior capturing modality and a subsequent portion of the at least one content data comprising the content stream corresponding to a subsequent capturing modality based on timestamps.

Further, maintaining continuity of tracking may include aligning the prior portion and the subsequent portion based on a calibration relationship between the prior capturing modality and the subsequent capturing modality. Further, the calibration relationship may comprise at least one of intrinsic calibration parameters, extrinsic calibration parameters, and a spatial transform mapping coordinates of the prior capturing modality to coordinates of the subsequent capturing modality. Further, the calibration relationship may be obtained from device calibration data stored in memory, computed during a calibration procedure, or retrieved from a configuration profile associated with the at least one content source device.

Further, maintaining continuity of tracking may include transferring a track state associated with the at least one entity across the change capturing. Further, the track state may comprise at least one of an entity identifier, a state vector, a covariance, or an appearance embedding, thereby providing a persistent representation of the at least one entity across modality segments of the at least one content data.

Further, maintaining continuity of tracking may include performing cross-modality re-identification based on the appearance embedding using a learned embedding transform. Further, the learned embedding transform may map modality-specific embeddings into a shared embedding space in which similarity comparisons are performed to preserve identity assignments across modality changes.

Further, maintaining continuity of tracking may include updating the track state using a state estimator selected from the group consisting of a Kalman filter, an extended Kalman filter, an unscented Kalman filter, and a particle filter, based on modality-specific measurement uncertainty. Further, the modality-specific measurement uncertainty may be assigned based on known sensor characteristics (e.g., depth noise, resolution limits, frame-rate differences), thereby enabling consistent estimation across heterogeneous modality segments.

Further, in some embodiments, the at least one content source device may perform edge processing to generate tracking metadata associated with the content stream corresponding to a currently active capturing modality. Further, the tracking metadata may comprise at least one of an entity identifier, a bounding region, a keypoint set, a confidence score, or a timestamp.

Further, the tracking metadata may be transmitted with the content stream or as a side channel synchronized to the content stream, such that the analyzing using the at least one tracking algorithm may be further based on the tracking metadata. Further, use of tracking metadata may reduce downstream compute load, reduce end-to-end latency, and provide a stable time base for track continuity across modality changes.

Further, the method may include enforcing at least one real-time performance criterion comprising at least one of a tracking latency threshold, an identity-switch rate threshold, or a track-loss rate threshold. Further, enforcing the at least one real-time performance criterion may include adaptively adjusting at least one streaming parameter comprising bitrate, frame rate, resolution, or region-of-interest encoding, and at least one capture parameter comprising exposure, gain, frame rate, resolution, focus, or field of view.

Further, the region-of-interest encoding may prioritize encoding resources for a region containing at least one entity of the plurality of entities, thereby preserving tracking-relevant detail while meeting latency constraints. Further, the capture parameters may be adjusted responsive to modality selection and environmental conditions to maintain target observability and stabilize downstream association accuracy.

Further, in some embodiments, the at least one content source device may comprise a plurality of capturing modality subsystems. Further, each capturing modality subsystem may include at least one sensor, at least one corresponding analog front-end and/or sensor interface circuit, and at least one sensor-specific signal processing pipeline, such that the content source device is capable of selectively capturing a physical activity using one capturing modality at a time or by switching between capturing modalities during a capture session.

Further, in some embodiments, a visible-light capturing modality subsystem may comprise a visible-light sensor. Further, the visible-light sensor is and/or may include a digital image sensor (e.g., CMOS/CCD), a lens assembly, and an image signal processor (ISP) configured to output frames for streaming.

Further, in some embodiments, a non-visible-light capturing modality subsystem may comprise a non-visible-light sensor. Further, the non-visible-light sensor is and/or may include at least one of: (i) an infrared imaging sensor with an infrared-capable optical assembly, (ii) a depth-sensing subsystem including a time-of-flight sensor or a structured-light projector and corresponding sensor with a depth computation module configured to output depth frames, (iii) a radar subsystem including a radar transceiver and baseband processing unit configured to output range-Doppler data or a point cloud, (iv) a lidar subsystem including a laser emitter and photodetector with time-of-flight processing configured to output distance measurements or a point cloud, (v) an acoustic subsystem including a microphone array and audio codec configured to output audio samples, and (vi) an inertial subsystem including an inertial measurement unit configured to output motion samples with timestamps.

Further, in some embodiments, the plurality of capturing modality subsystems may include a first camera having a first viewpoint and a second camera c having a second viewpoint different from the first viewpoint, thereby providing different viewpoint geometry for capturing the physical activity.

Further, in some embodiments, the content source device may include a modality controller implemented by at least one processor executing firmware and/or dedicated switching logic that controls which capturing modality subsystem is active. Further, the modality controller may activate a target capturing modality by configuring sensor settings, selecting sensor data paths, and enabling an encoder or streaming module corresponding to the target capturing modality responsive to a received control command.

Further, in some embodiments, the at least one content data may comprise one or more content streams transmitted from the at least one content source device to the communication device. Further, a content stream may comprise a sequence of time-ordered frames or samples (e.g., video frames, depth maps, radar outputs, audio samples, IMU samples), each associated with a timestamp and a modality identifier.

Further, in some embodiments, a content stream segment may include metadata comprising at least one of a stream identifier, modality identifier, frame index, timestamp, sampling rate, resolution, and encoder parameters. Further, timestamps may be generated using a device clock and, in some embodiments, synchronized to a common time base used by the communication device.

Further, an “instance” may correspond to at least one of (i) a timestamp, (ii) a frame index, or (iii) a sequence number. Further, a “duration” may correspond to a time interval of a capture session represented by a timestamp range and/or a frame/sample count. Further, the at least one content data may comprise successive time-ordered segments associated with different capturing modalities over the duration due to one or more modality switches.

Further, in some embodiments, the at least one machine learning model used during the receiving pipeline may be distinct from a tracking algorithm used after receiving the at least one content data. Further, the machine learning model may be configured to predict an occlusion event and/or an occlusion time for a currently active modality stream.

Further, inputs to the machine learning model may include at least one of current and prior frames, motion features (e.g., optical flow or motion vectors), detected entity regions, keypoint heatmaps, segmentation masks, depth values, or point-cloud features. Further, outputs may include at least one of an occlusion probability, a predicted occlusion instance (timestamp/frame index), a predicted occlusion type, a predicted overlap metric, or a predicted keypoint visibility value.

Further, in some embodiments, the machine learning model may be executed by an inference engine implemented in software on a processor, on a neural processing unit, in firmware, or in combination thereof.

Further, in some embodiments, determining a second capturing modality as being suitable for overcoming an entity occlusion event may include evaluating candidate modalities using a visibility criterion for at least one entity. Further, the visibility criterion may be computed based on at least one of an estimated occluder location, an estimated entity pose/trajectory, a line-of-sight assessment relative to a candidate camera viewpoint, and a field-of-view intersection assessment.

Further, in some embodiments, when the predicted occlusion is a line-of-sight obstruction in a visible-light stream, the second capturing modality may be selected from a non-visible-light modality (e.g., depth, radar) that remains informative despite visible-spectrum obstruction. Further, when the predicted occlusion is viewpoint-dependent, the second capturing modality may be selected as a different camera capturing modality having a different viewpoint.

Further, in some embodiments, the control command transmitted to the at least one content source device may include at least one of a target modality identifier, an activation instance (timestamp/frame index), and at least one capture parameter (exposure, gain, frame rate, resolution, focus, field of view), and optionally at least one viewpoint-control parameter (pan, tilt, zoom) for camera capturing modalities.

Further, the content source device may apply the control command by deactivating the current modality at the activation instance and activating the target modality at the activation instance, and by streaming a content stream segment for the target modality beginning at the activation instance.

Further, in some embodiments, after the at least one content data is received, the processing device may apply a tracking algorithm configured to track the plurality of entities over time and support determining associations between entities. Further, the tracking algorithm may be distinct from the machine learning model used for occlusion prediction during receiving.

Further, maintaining continuity across modality switches may include: time-synchronizing prior and subsequent content stream segments using timestamps; aligning segments using a calibration relationship between modalities (intrinsic parameters, extrinsic parameters, and/or a spatial transform between coordinate systems); transferring a track state (entity identifier, state vector, covariance, and/or appearance embedding); performing cross-modality re-identification using the appearance embedding; and updating the track state using a state estimator (e.g., Kalman-family or particle filter) with modality-dependent measurement uncertainty.

Further, in some embodiments, the at least one content source device may perform edge processing to generate tracking metadata including at least one of entity identifiers, bounding regions, keypoints, confidence scores, and timestamps. Further, tracking metadata may be transmitted with the content stream or as a synchronized side channel.

Further, the processing device may use the tracking metadata to reduce compute load and/or reduce latency for downstream tracking and association.

Further, in some embodiments, the system may enforce at least one real-time performance criterion comprising at least one of a tracking latency threshold, an identity-switch rate threshold, or a track-loss rate threshold. Further, to satisfy the criterion, the system may adaptively adjust streaming parameters (bitrate, frame rate, resolution, region-of-interest encoding) and/or capture parameters (exposure, gain, frame rate, resolution, focus, field of view, pan/tilt/zoom).

Further, region-of-interest encoding may allocate higher encoding quality to regions containing tracked entities while reducing quality elsewhere to meet bandwidth and latency constraints.

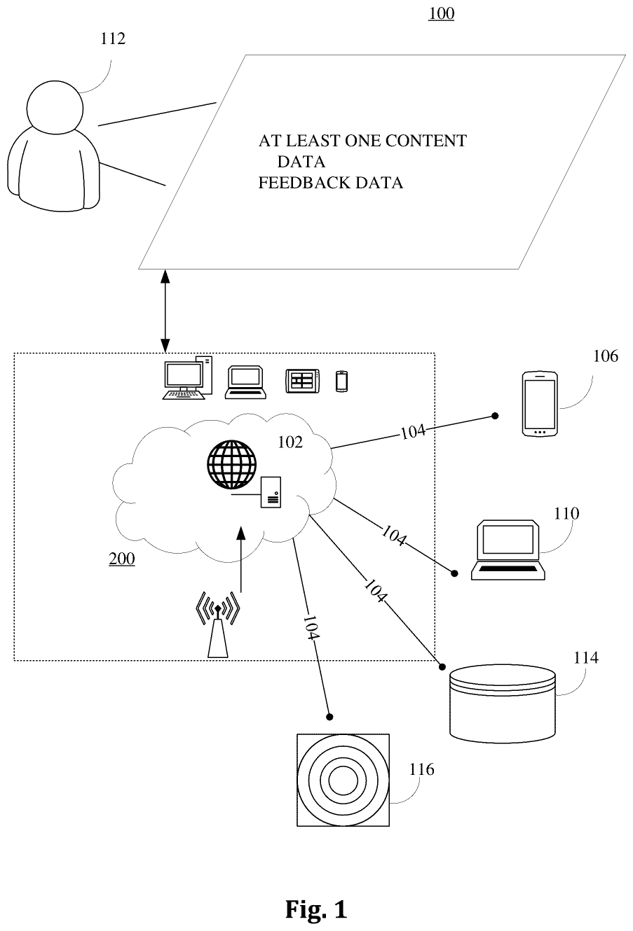

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

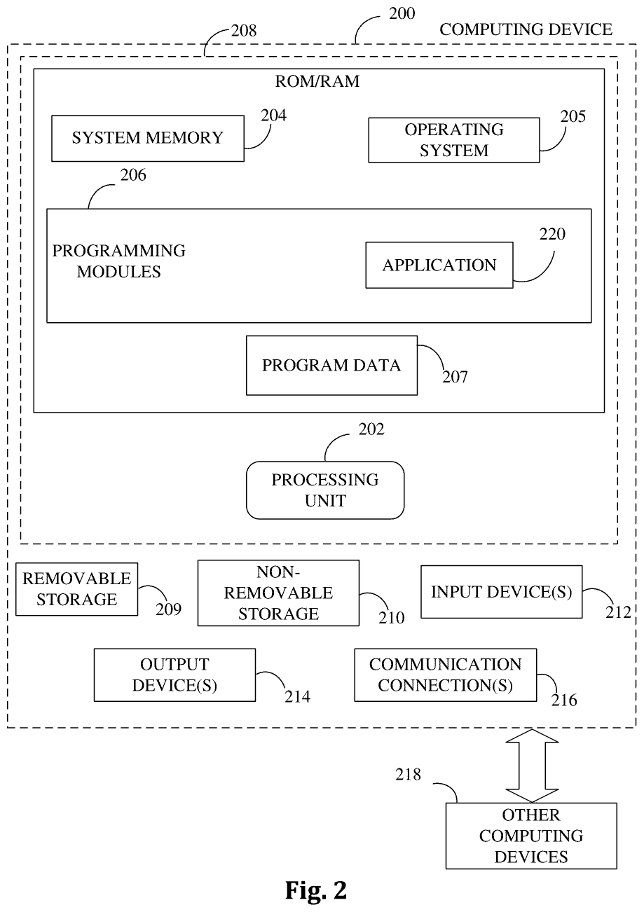

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

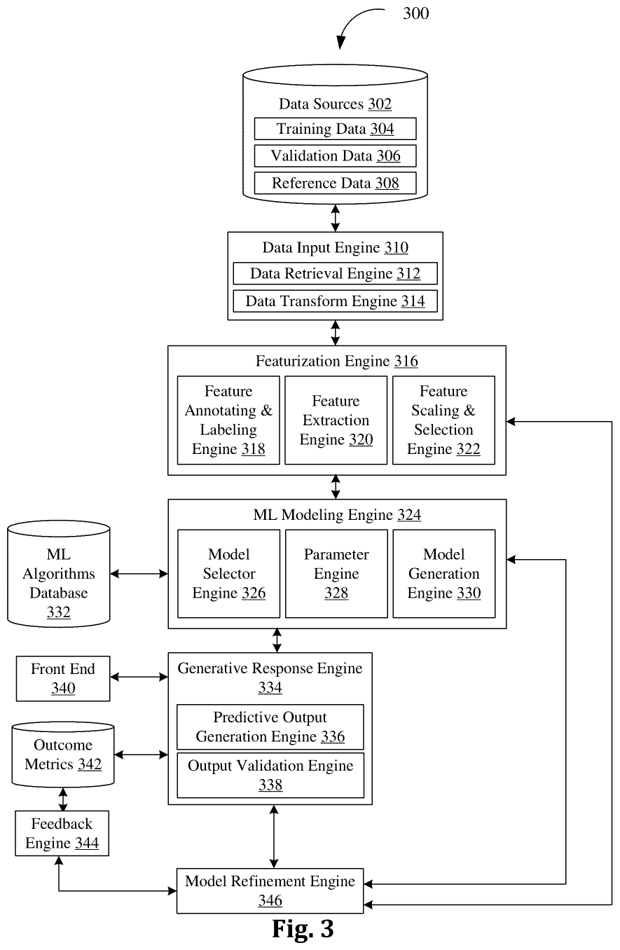

FIG. 3 is a block diagram illustrating a machine-learning system 300 for implementing various embodiments of this disclosure, in accordance with some embodiments. Although the disclosed machine-learning system 300 depicts particular system components and an arrangement of such components, the given depiction is to facilitate a discussion of the present technology and should not be considered limiting unless specified in the appended claims. For example, some components that are illustrated as separate may be combined with other components, and some components may be divided into separate components.

Accordingly, the machine-learning system 300 may include a plurality of interrelated modules and engines configured to implement a machine-learning pipeline. Further, the machine-learning system 300 may include a data sources module 302 that is made up of a training data repository 304, a validation data repository 306, and a reference data repository 308, each repository being configured to store respective classes of input records and reference information. Further, the machine-learning system 300 may include a data input engine 310 configured to receive data from the data sources module 302. Further, the data input engine 310 may include a data retrieval engine 312 configured to access and ingest data from the repositories (304, 306, 308), and a data transform engine 314 configured to perform initial normalization, parsing and format conversion on the ingested data. Further, the machine-learning system 300 may include a featurization engine 316 configured to prepare temporal and predictive representations of transformed data. Further, the featurization engine 316 may include a feature annotating & labeling engine 318 for applying labels and annotations to data instances, a feature extraction engine 320 for deriving feature vectors and candidate predictors, and a feature scaling & selection engine 322 for performing numerical scaling, dimensionality reduction, and selection of salient features. Further, the machine-learning system 300 may include a machine learning (ML) modeling engine 324 configured to construct predictive models from selected features. Further, the ML modeling engine 324 may include a model selector engine 326 for selecting among candidate model classes, a parameter engine 328 for determining and tuning hyperparameters, and a model generation engine 330 for instantiating and training model artifacts according to selected architectures and parameters. Further, the machine-learning system 300 may include an ML algorithms database 332 configured to store algorithmic implementations, model templates, and associated metadata and to be accessible by components of the ML modeling engine 324. Further, the machine-learning system 300 may include a generative response engine 334 configured to produce user-facing outputs based on the trained models. Further, the generative response engine 334 may include a predictive output generation engine 336 for generating predictions or synthesized responses and an output validation engine 338 for verifying, filtering and validating generated outputs against predefined criteria and reference data. Further, the machine-learning system 300 may include a front end 340 configured to present validated outputs to end users and to collect interaction signals. Further, the machine-learning system 300 may include an outcome metrics module 342 configured to compute performance measures, accuracy statistics and other evaluation metrics derived from model outputs and user interactions. Further, the machine-learning system 300 may include a feedback engine 344 configured to aggregate outcome metrics and user feedback and to format such information for reuse. Further, the machine-learning system 300 may include a model refinement engine 346 configured to receive feedback from the feedback engine 344 and the outcome metrics module 342, and to effect iterative updates to the ML modeling engine 324 and to the ML algorithms database 332. Further, the components are communicatively coupled so that data and control signals are exchanged among the repositories (304, 306, 308), the data input engine 310, the featurization engine 316, the ML modeling engine 324 (with algorithmic support from the ML algorithms database 332), the generative response engine 334, and the front end 340 for output generation. Further, the outcome metrics 342 and feedback engine 344 provide closed-loop signals to the model refinement engine 346 to enable retraining, parameter adjustment, and algorithm selection, thereby enabling cooperative execution of data acquisition, feature engineering, model construction, output generation, validation, evaluation, and iterative refinement within the disclosed machine-learning system 300.

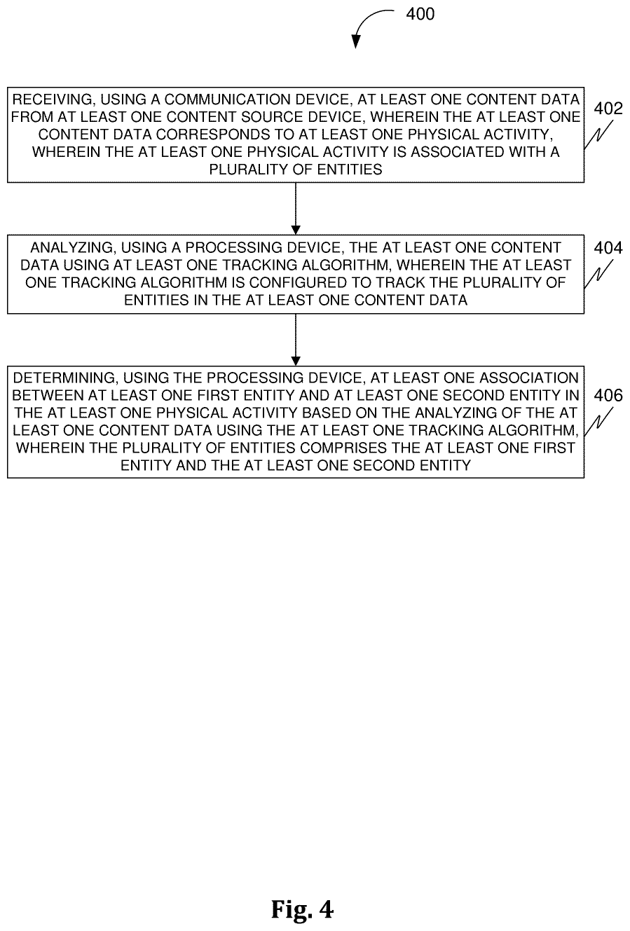

FIG. 4 illustrates a flowchart of a method 400 of facilitating dynamic entity association, in accordance with some embodiments. Further, the method 400 may include a step 402 of receiving, using a communication device 802, one or more content data from one or more content source devices 806. Further, the one or more content data corresponds to one or more physical activities. Further, the one or more physical activities may be associated with two or more entities. Further, the method 400 may include a step 404 of analyzing, using a processing device 804, the one or more content data using one or more tracking algorithms. Further, the one or more tracking algorithms may be configured to track the two or more entities in the one or more content data. Further, the method 400 may include a step 406 of determining, using the processing device 804, one or more associations between one or more first entities and one or more second entities in the one or more physical activities based on the analyzing of the one or more content data using the one or more tracking algorithms. Further, the two or more entities include the one or more first entities and the one or more second entities.

In some embodiments, the method 400 further may include analyzing, using the processing device 804, the one or more content data using one or more neural networks. Further, in some embodiments, the method 400 further may include identifying, using the processing device 804, each of the two or more entities in the one or more content data using the one or more neural networks based on the analyzing of the one or more content data using the one or more neural networks. Further, the analyzing of the one or more content data may be further based on the identifying of each of the two or more entities. Further, the analyzing of the one or more content data includes analyzing each of the two or more entities in the one or more content data using the one or more tracking algorithms. Further, the one or more tracking algorithms may be configured to track each of two or more entities in the one or more content data based on the identifying of each of the two or more entities.

In some embodiments, the method 400 may further include generating, using the processing device 804, two or more confidence scores using the one or more neural networks based on the identifying of each of the two or more entities. Further, the two or more confidence scores correspond to the two or more entities. Further, the two or more confidence scores indicate an accuracy of the identifying of each of the two or more entities. Further, the analyzing of each of the two or more entities in the one or more content data may be further based on the two or more confidence scores. Further, the one or more tracking algorithms may be configured to track the two or more entities in the one or more content data based on the two or more confidence scores.

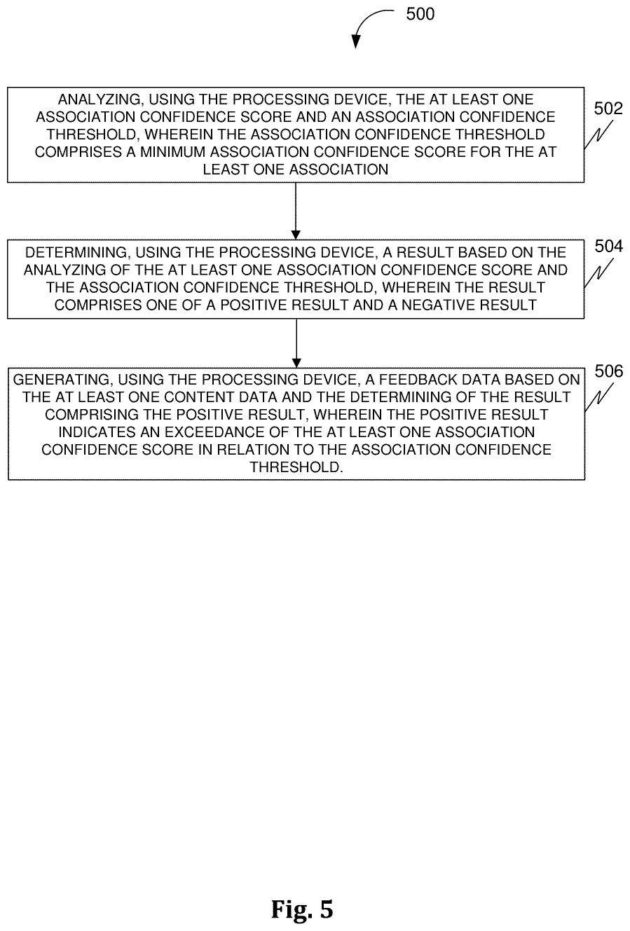

FIG. 5 illustrates a flowchart of a method 500 of facilitating dynamic entity association, in accordance with some embodiments. Further, the determining of the one or more associations includes computing one or more association confidence scores of the one or more associations. Further, the one or more association confidence scores may quantify an accuracy of the one or more associations. Further, the method 500 may include a step 502 of analyzing, using the processing device 804, the one or more association confidence scores and an association confidence threshold. Further, the association confidence threshold may include a minimum association confidence score of the one or more associations. Further, the method 500 may include a step 504 of determining, using the processing device 804, a result based on the analyzing of the one or more association confidence scores and the association confidence threshold. Further, the result may include one of a positive result and a negative result. Further, the method 500 may include a step 506 of generating, using the processing device 804, a feedback data based on the one or more content data and the determining of the result comprising the positive result. Further, the positive result may indicate an exceedance of the one or more association confidence scores in relation to the association confidence threshold.

In some embodiments, the analyzing of the one or more content data includes analyzing the one or more content data based on one or more association rules. Further, the determining of the one or more associations may be based on the analyzing of the one or more content data based on the one or more association rules. Further, the one or more association rules comprise one or more of a time-based association rule and a frame-based association rule.

In some embodiments, the method 400 may further include determining, using the processing device 804, two or more trajectories of the two or more entities in the one or more physical activities based on the analyzing of the one or more content data using the one or more tracking algorithms. Further, the two or more trajectories correspond to two or more paths predicted to be followed by the two or more entities in the one or more physical activities. Further, the determining of the one or more associations between the one or more first entities and the one or more second entities may be further based on the two or more trajectories of the two or more entities.

In some embodiments, the two or more trajectories comprise one or more first trajectories corresponding to the one or more first entities and one or more second trajectories corresponding to the one or more second entities. Further, the method 400 may further include determining, using the processing device 804, one or more correlations between the one or more first trajectories and the one or more second trajectories based on the two or more trajectories. Further, the determining of the one or more associations may be further based on the determining of the one or more correlations between the one or more first trajectories and the one or more second trajectories.

In some embodiments, the method 400 may further include determining, using the processing device 804, two or more motion data based on the analyzing of the one or more content data. Further, the two or more motion data comprises two or more motion vectors representing two or more motions of the two or more entities in the one or more physical activities. Further, the determining of the one or more associations is further based on the two or more motion data.

In some embodiments, the two or more motion data comprises one or more first motion data corresponding to the one or more first entities and one or more second motion data corresponding to the one or more second entities. Further, the method 400 may further include determining, using the processing device, an alignment between the one or more first motion data and the one or more second motion data based on the two or more motion data. Further, the determining of the one or more associations is further based on the determining of the alignment between the one or more first motion data and the one or more second motion data.

In some embodiments, the two or more motion vectors comprise one or more of two or more velocity vectors of the two or more entities and two or more acceleration vectors of the two or more entities. Further, the two or more velocity vectors of the two or more entities indicate two or more velocities of the two or more entities in the one or more physical activities. Further, the two or more acceleration vectors of the two or more entities indicate two or more accelerations of the two or more entities in the one or more physical activities.

In some embodiments, the two or more motion data comprises the two or more motion vectors representing the two or more motions of the two or more entities in the one or more physical activities over a time interval.

In some embodiments, the method 400 may further include determining, using the processing device 804, one or more occlusion events of one or more of the two or more entities in the one or more content data based on the analyzing of the one or more content data. Further, the one or more occlusion events of one or more of the two or more entities correspond to an occlusion of one or more of the two or more entities in the one or more content data. Further, the determining of the one or more associations may be further based on the determining of the one or more occlusion events. Further, the determining of the one or more associations comprise determining the one or more associations in the one or more occlusion events based on the two or more trajectories of the two or more entities.

In some embodiments, the method 400 further comprises identifying, using the processing device 804, the two or more entities in the one or more content data using the one or more tracking algorithms based on the determining of the one or more occlusion events. Further, the one or more tracking algorithms may be configured to perform a re-identification of the two or more entities in relation to the one or more occlusion events. Further, the one or more tracking algorithms may be configured to track the two or more entities in the one or more content data by the performing of the re-identification of the two or more entities.

In some embodiments, the performing of the re-identification of the two or more entities comprises performing the re-identification of the two or more entities in the one or more content data using a motion model. Further, the motion model corresponds to a mathematical model defining a movement of the two or more entities in the one or more physical activities.

In some embodiments, the performing of the re-identification of the two or more entities comprises performing the re-identification of the two or more entities in the one or more content data based on one or more appearance embeddings. Further, the one or more appearance embeddings correspond to one or more numerical representations of one or more appearances of the two or more entities in the one or more content data.

In some embodiments, the one or more content data includes one or more videos comprising two or more video frames. Further, the analyzing of the one or more content data includes analyzing each of the two or more video frames using the one or more tracking algorithms. Further, the determining of the one or more associations between the one or more first entities and the one or more second entities in the one or more physical activities may be based on the analyzing of each of the two or more video frames using the one or more tracking algorithms. Further, the one or more tracking algorithms may be configured to track the two or more entities in each of the two or more video frames using a multi-frame optimization technique.

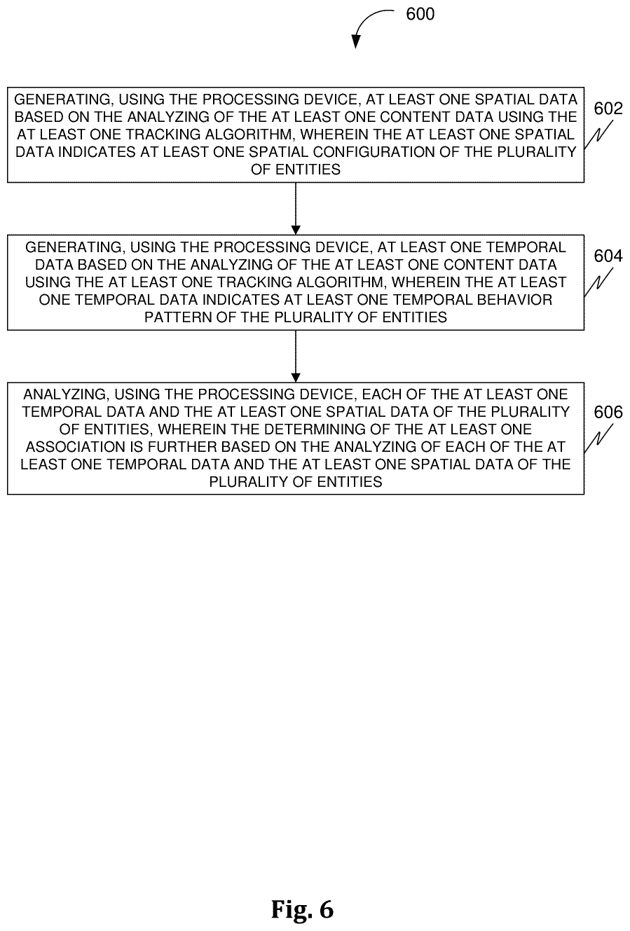

FIG. 6 illustrates a flowchart of a method 600 of facilitating dynamic entity association including analyzing, using the processing device 804, each of the at least one temporal data and the at least one spatial data of the plurality of entities, in accordance with some embodiments. Further, in some embodiments, the method 600 further may include a step 602 of generating, using the processing device 804, one or more spatial data based on the analyzing of the one or more content data using the one or more tracking algorithms. Further, the one or more spatial data indicate one or more spatial configurations of the two or more entities. Further, in some embodiments, the method 600 further may include a step 604 of generating, using the processing device 804, one or more temporal data based on the analyzing of the one or more content data using the one or more tracking algorithms. Further, the one or more temporal data indicate one or more temporal behavior patterns of the two or more entities. Further, in some embodiments, the method 600 further may include a step 606 of analyzing, using the processing device 804, each of the one or more temporal data and the one or more spatial data of the two or more entities. Further, the determining of the one or more associations may be further based on the analyzing of each of the one or more temporal data and the one or more spatial data of the two or more entities.

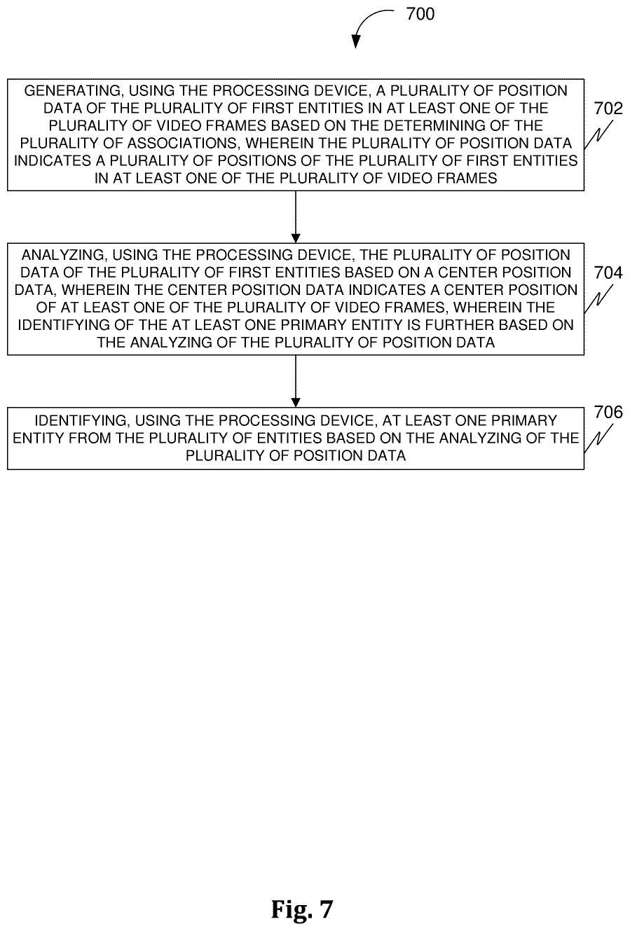

FIG. 7 illustrates a flowchart of a method 700 of facilitating dynamic entity association including identifying, using the processing device 804, at least one primary entity from the plurality of entities, in accordance with some embodiments. Further, in some embodiments, the one or more first entities may include two or more first entities. Further, the one or more second entities may include two or more second entities. Further, the determining of the one or more associations may include determining two or more associations between the two or more first entities and the two or more second entities. Further, the one or more content data may include one or more videos including two or more video frames. Further, the method 700 further may include a step 702 of generating, using the processing device 804, two or more position data of the two or more first entities in one or more of the two or more video frames based on the determining of the two or more associations. Further, the two or more position data indicates two or more positions of the two or more first entities in one or more of the two or more video frames. Further, the method 700 further may include a step 704 of analyzing, using the processing device 804, the two or more position data of the two or more first entities based on a center position data. Further, the center position data indicates a center position of one or more of the two or more video frames. Further, the method 700 further may include a step 706 of identifying, using the processing device 804, one or more primary entities from the two or more entities based on the analyzing of the two or more position data.

In some embodiments, the method 700 may further include determining, using the processing device 804, two or more proximity data based on the analyzing of the two or more position data of the two or more first entities based on the center position data. Further, the two or more proximity data indicates a proximity of the two or more entities to the center position of one or more of the two or more video frames. Further, the identifying of the one or more primary entities from the two or more first entities may be further based on the determining of the two or more proximity data.

In some embodiments, the method 400 may further include assigning, using the processing device 804, two or more identifiers to the two or more entities using the one or more tracking algorithms. Further, the analyzing of the one or more content data may be further based on the assigning of the two or more identifiers. Further, the analyzing of the one or more content data includes analyzing the two or more entities in the one or more content data using the one or more tracking algorithms based on the two or more identifiers. Further, the one or more tracking algorithms may be configured to track the two or more entities in the one or more content data based on the two or more identifiers. Further, the method 400 may include generating, using the processing device 804, a composite object data based on the determining of the one or more associations and the two or more identifiers. Further, the composite object data corresponds to a composite object comprising each of the one or more first entities and the one or more second entities. Further, the composite object data comprises each of the one or more first identifiers of the one or more first entities, one or more second identifiers of the one or more second entities, a time interval of the one or more associations, and one or more association confidence scores of the one or more associations. Further, the two or more identifiers comprise the one or more first identifiers and the one or more second identifiers.

In some embodiments, the composite object data may be dynamically updated.

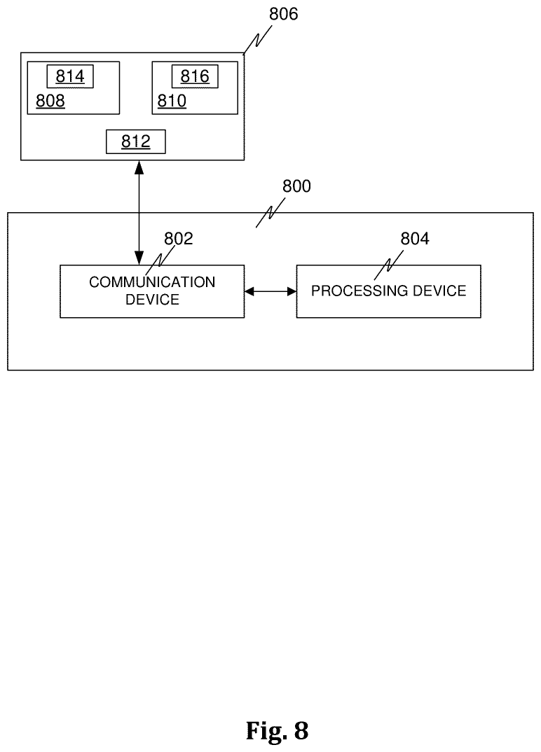

FIG. 8 illustrates a block diagram of a system 800 of facilitating dynamic entity association, in accordance with some embodiments. Further, the system 800 may include a communication device 802 which may be configured for receiving one or more content data from one or more content source devices 806. Further, the one or more content data corresponds to one or more physical activities. Further, the one or more physical activities may be associated with two or more entities. Further, the system 800 may include a processing device 804 communicatively coupled with the communication device 802. Further, the processing device 804 may be configured for analyzing the one or more content data using one or more tracking algorithms. Further, the one or more tracking algorithms may be configured to track the two or more entities in the one or more content data. Further, the processing device 804 may be configured for determining one or more associations between one or more first entities and one or more second entities in the one or more physical activities based on the analyzing of the one or more content data using the one or more tracking algorithms. Further, the two or more entities include the one or more first entities and the one or more second entities.

Further, in some embodiments, the processing device 804 may be further configured for analyzing the one or more content data using one or more neural networks. Further, the processing device 804 may be further configured for identifying each of the two or more entities in the one or more content data using the one or more neural networks based on the analyzing of the one or more content data using the one or more neural networks. Further, the analyzing of the one or more content data may be further based on the identifying of each of the two or more entities. Further, the analyzing of the one or more content data includes analyzing each of the two or more entities in the one or more content data using the one or more tracking algorithms. Further, the one or more tracking algorithms may be configured to track each of two or more entities in the one or more content data based on the identifying of each of the two or more entities.

In some embodiments, the processing device 804 may be further configured for generating two or more confidence scores using the one or more neural networks based on the identifying of each of the two or more entities. Further, the two or more confidence scores correspond to the two or more entities. Further, the two or more confidence scores indicate an accuracy of the identifying of each of the two or more entities. Further, the analyzing of each of the two or more entities in the one or more content data may be further based on the two or more confidence scores. Further, the one or more tracking algorithms may be configured to track the two or more entities in the one or more content data based on the two or more confidence scores.

In some embodiments, the processing device 804 may be further configured for determining two or more trajectories of the two or more entities in the one or more physical activities based on the analyzing of the one or more content data using the one or more tracking algorithms. Further, the two or more trajectories correspond to two or more paths predicted to be followed by the two or more entities in the one or more physical activities. Further, the determining of the one or more associations between the one or more first entities and the one or more second entities may be further based on the two or more trajectories of the two or more entities.

In some embodiments, the determining of the one or more associations includes computing one or more association confidence scores of the one or more associations. Further, the one or more association confidence scores may quantify an accuracy of the one or more associations. Further, the processing device 804 may be further configured for analyzing the one or more association confidence scores and an association confidence threshold. Further, the association confidence threshold may include a minimum association confidence score of the one or more associations. Further, the processing device 804 may be further configured for determining a result based on the analyzing of the one or more association confidence scores and the association confidence threshold. Further, the result may include one of a positive result and a negative result. Further, the processing device 804 may be configured for generating a feedback data based on the one or more content data and the determining of the result comprising the positive result. Further, the positive result may indicate an exceedance of the one or more association confidence scores in relation to the association confidence threshold.

In some embodiments, the analyzing of the one or more content data includes analyzing the one or more content data based on one or more association rules. Further, the determining of the one or more associations may be based on the analyzing of the one or more content data based on the one or more association rules. Further, the one or more association rules comprise one or more of a time-based association rule and a frame-based association rule.

In some embodiments, the processing device 804 may be further configured for determining one or more occlusion events of one or more of the two or more entities in the one or more content data based on the analyzing of the one or more content data. Further, the one or more occlusion events of one or more of the two or more entities correspond to an occlusion of one or more of the two or more entities in the one or more content data. Further, the determining of the one or more associations may be further based on the determining of the one or more occlusion events. Further, the determining of the one or more associations comprises determining the one or more associations in the one or more occlusion events based on the two or more trajectories of the two or more entities.

In some embodiments, the one or more content data includes one or more videos comprising two or more video frames. Further, the analyzing of the one or more content data includes analyzing each of the two or more video frames using the one or more tracking algorithms. Further, the determining of the one or more associations between the one or more first entities and the one or more second entities in the one or more physical activities may be based on the analyzing of each of the two or more video frames using the one or more tracking algorithms. Further, the one or more tracking algorithms may be configured to track the two or more entities in each of the two or more video frames using a multi-frame optimization technique.

Further, in some embodiments, the processing device 804 may be further configured for generating one or more spatial data based on the analyzing of the one or more content data using the one or more tracking algorithms. Further, the one or more spatial data indicate one or more spatial configurations of the two or more entities. Further, the processing device 804 may be further configured for generating one or more temporal data based on the analyzing of the one or more content data using the one or more tracking algorithms. Further, the one or more temporal data indicate one or more temporal behavior patterns of the two or more entities. Further, the processing device 804 may be further configured for analyzing each of the one or more temporal data and the one or more spatial data of the two or more entities. Further, the determining of the one or more associations may be further based on the analyzing of each of the one or more temporal data and the one or more spatial data of the two or more entities.

Further, in some embodiments, the one or more first entities may include two or more first entities. Further, the one or more second entities may include two or more second entities. Further, the determining of the one or more associations may include determining two or more associations between the two or more first entities and the two or more second entities. Further, the one or more content data may include one or more videos may include two or more video frames. Further, the processing device 804 may be further configured for generating two or more position data of the two or more first entities in one or more of the two or more video frames based on the determining of the two or more associations. Further, the two or more position data indicates two or more positions of the two or more first entities in one or more of the two or more video frames. Further, the processing device 804 may be further configured for analyzing the two or more position data of the two or more first entities based on a center position data. Further, the center position data indicates a center position of one or more of the two or more video frames. Further, the processing device 804 may be further configured for identifying one or more primary entities from the two or more entities based on the analyzing of the two or more position data.

In some embodiments, the processing device 804 may be further configured for determining two or more proximity data based on the analyzing of the two or more position data of the two or more first entities based on the center position data. Further, the two or more proximity data indicate a proximity of the two or more entities to the center position of one or more of the two or more video frames. Further, the identifying of the one or more primary entities from the two or more first entities may be further based on the determining of the two or more proximity data.

In some embodiments, the processing device 804 may be further configured for assigning two or more identifiers to the two or more entities using the one or more tracking algorithms. Further, the analyzing of the one or more content data may be further based on the assigning of the two or more identifiers. Further, the analyzing of the one or more content data includes analyzing the two or more entities in the one or more content data using the one or more tracking algorithms based on the two or more identifiers. Further, the one or more tracking algorithms may be configured to track the two or more entities in the one or more content data based on the two or more identifiers. Further, the processing device 804 may be further configured for generating a composite object data based on the determining of the one or more associations and the two or more identifiers. Further, the composite object data corresponds to a composite object comprising each of the one or more first entities and the one or more second entities. Further, the composite object data comprises each of the one or more first identifiers of the one or more first entities, one or more second identifiers of the one or more second entities, a time interval of the one or more associations, and one or more association confidence scores of the one or more associations. Further, the two or more identifiers comprise the one or more first identifiers and the one or more second identifiers.

Further, in some embodiments, the one or more content source devices 806 may comprise two or more capturing modality subsystems 808-810 and a modality controller 812. Further, the two or more capturing modality subsystems 808-810 may include one or more visible-light capturing modality subsystems 808 and one or more non-visible-light capturing modality subsystems 810. Further, the one or more visible-light capturing modality subsystems 808 may include a visible-light sensor 814, and the one or more non-visible-light capturing modality subsystems 810 may include a non-visible-light sensor 816.

In some embodiments, the negative result indicates a non-exceedance of the one or more association confidence scores in relation to the association confidence threshold.

In some embodiments, the time-based association rule indicates a minimum time duration of the one or more associations. Further, the one or more first entities may be associated with the one or more second entities over an actual time duration. Further, the actual time duration may exceed the minimum time duration.

In some embodiments, the method 400 may further include determining, using the processing device 804, two or more probabilities of two or more associations of the two or more entities over a time interval based on the analyzing of the one or more content data. Further, the two or more probabilities include a transient probability. Further, the method 400 may include processing, using the processing device 804, the two or more probabilities to filter the transient probability. Further, the method 400 may include obtaining, using the processing device 804, two or more processed probabilities based on the processing of the two or more probabilities. Further, the two or more processed probabilities lack the transient probability. Further, the determining of the one or more associations may be further based on the obtaining of the two or more processed probabilities.

In some embodiments, the method 500 further includes analyzing, using the processing device, the one or more association confidence scores of the one or more associations. Further, the method 500 further includes determining, using the processing device, a change in the one or more association confidence scores over a time interval. Further, the method 500 includes determining, using the processing device, a handoff event in the one or more physical activities based on the determining of the change in the one or more association confidence scores. Further, the determining of the one or more associations is further based on the determining of the handoff event in the one or more physical activities.

In some embodiments, the one or more first entities comprise a plurality of players comprising a first player and a second player. Further, the one or more second entities comprise a ball. Further, the handoff event occurs between the first player and the second player in the one or more physical activities.

In some embodiments, the handoff event indicates an occurrence of passing the ball from the first player to the second player in an absence of throwing the ball from the first player to the second player.

In some embodiments, the method 600 may further include identifying, using the processing device 804, one or more primary entities from the two or more entities based on the determining of the one or more associations. Further, the method 600 may further include determining, using the processing device 804, a role of the one or more primary entities in the one or more physical activities based on the identifying of the one or more primary entities.

In some embodiments, the determining of the role of the one or more primary entities is further based on the analyzing of the one or more spatial data and the one or more temporal data.

In some embodiments, the analyzing of the one or more spatial data and the one or more temporal data comprises analyzing the one or more spatial data based on the sport-aware spatial zones, and the one or more temporal data. Further, the determining of the role of the one or more primary entities is based on the analyzing of the one or more spatial data based on the sport-aware spatial zones, and the one or more temporal data.

In some embodiments, the method 700 may further include determining, using the processing device 804, two or more temporal behavior patterns of the two or more entities in the one or more physical activities based on the analyzing of the one or more spatial data and the one or more temporal data. Further, the determining of the role of the one or more primary entities is based on the determining of the two or more temporal behavior patterns of the two or more entities.

In some embodiments, the identifying of the one or more primary entities from the two or more entities comprises identifying the one or more primary entities from the two or more entities using one or more of an association confidence score, a spatial zone probability, a motion correlation, and a temporal persistence.

In some embodiments, the identifying of the one or more primary entities from the two or more entities comprises identifying the one or more primary entities from the two or more entities based on a weighted combination of each of an association confidence score, a spatial zone probability, a motion correlation, and a temporal persistence.

In some embodiments, the two or more trajectories include one or more first trajectories corresponding to the one or more first entities and one or more second trajectories corresponding to the one or more second entities. Further, the determining of the one or more associations includes determining the one or more associations between the one or more first entities and the one or more second entities based on the one or more first trajectories and the one or more second trajectories.

In some embodiments, one or more of the two or more entities includes the one or more second entities. Further, the one or more second entities may be occluded by the one or more first entities.

In some embodiments, the one or more physical activities may be performed by two or more players using one or more objects. Further, the one or more first entities include one or more players. Further, the one or more second entities include the one or more objects.

In some embodiments, the one or more physical activities include one or more sports activities. Further, the one or more objects include one or more sports equipment.

In some embodiments, the one or more composite objects include each of one or more players and one or more sports equipment.

In some embodiments, the one or more sports equipment includes one or more balls.

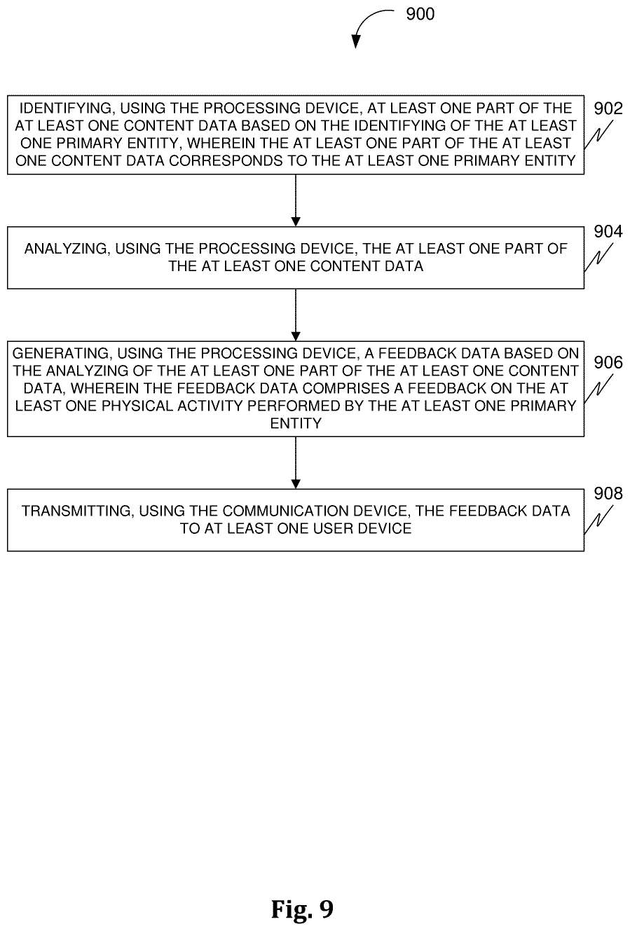

FIG. 9 illustrates a flowchart of a method 900 of facilitating dynamic entity association including generating, using the processing device 804, a feedback data, in accordance with some embodiments. Further, in some embodiments, the method 900 further may include a step 902 of identifying, using the processing device 804, one or more parts of the one or more content data based on the identifying of the one or more primary entities. Further, the one or more parts of the one or more content data correspond to the one or more primary entities. Further, in some embodiments, the method 900 further may include a step 904 of analyzing, using the processing device 804, the one or more parts of the one or more content data. Further, in some embodiments, the method 900 further may include a step 906 of generating, using the processing device 804, a feedback data based on the analyzing of the one or more parts of the one or more content data. Further, the feedback data includes a feedback on the one or more physical activities performed by the one or more primary entities. Further, in some embodiments, the method 900 further may include a step 908 of transmitting, using the communication device 802, the feedback data to one or more user devices.

In some embodiments, the one or more content data includes one or more videos of the one or more physical activities. Further, the two or more content data includes two or more video frames of the one or more videos.

In some embodiments, the one or more physical activities include one or more sports activities. Further, the one or more primary entities include one or more of a shooter, a goalkeeper, and a ball carrier.

In some embodiments, the one or more associations indicate one or more physical contacts between the one or more first entities and the one or more second entities. Further, the one or more physical contacts between the one or more first entities and the one or more second entities occur over a time interval.

In some embodiments, the one or more associations indicate one or more physical contacts between the one or more first entities and the one or more second entities inferred from one or more kinematic features over the time interval.

In some embodiments, the method 400 may further include receiving, using the communication device 802, one or more rule data from the one or more user devices. Further, the one or more rule data includes one or more rules for the determining of the one or more associations. Further, the determining of the one or more associations may be further based on the one or more rule data.

In some embodiments, the one or more physical activities may be performed by two or more players during an individual training session. Further, the two or more entities include the two or more players.

In some embodiments, the one or more physical activities may be associated with a dynamic sports environment.

In some embodiments, the one or more physical activities include a complex interaction.

In some embodiments, the one or more sports equipment includes one or more of a basketball, a football, and a hockey stick.

In some embodiments, the method 600 may further include determining, using the processing device 804, two or more movement patterns of the two or more entities based on the analyzing of each of the one or more temporal data and the one or more spatial data. Further, the identifying of the one or more primary entities may be further based on the determining of the two or more movement patterns of the two or more entities.

In some embodiments, the two or more movement patterns of the two or more entities comprise two or more temporal behavioral patterns of the two or more entities.

In some embodiments, the one or more physical activities include two or more phases associated with two or more predetermined movement patterns. Further, the one or more primary entities may be associated with one or more of the two or more predetermined movement patterns.

In some embodiments, the one or more physical activities correspond to a basketball sport. Further, the one or more primary entities include a shooter.

In some embodiments, the two or more phases include a transfer phase, a pocket phase, and a release phase.

In some embodiments, the one or more physical activities correspond to a Football sport. Further, the one or more primary entities include a ball holder. Further, the two or more movement patterns include a transition pattern of a football.

In some embodiments, the one or more physical activities correspond to a Hockey sport. Further, the one or more primary entities include a goalkeeper. Further, the one or more spatial data indicate the one or more spatial configurations of the two or more entities with a defensive zone.

In some embodiments, the one or more physical activities may be performed in an environment comprising a crowded sports environment.

In some embodiments, the one or more user devices may be associated with one or more coaches. Further, the one or more physical activities may be performed by the two or more entities comprising two or more players.

In some embodiments, the one or more user devices may include two or more user devices may be associated with two or more players. Further, the one or more physical activities may be performed by the two or more entities comprising the two or more players.

In some embodiments, the transmitting of the feedback data includes transmitting the feedback data using a real-time communication protocol.

In some embodiments, the feedback data includes a report representing the feedback on the one or more physical activities performed by the one or more primary entities.

In some embodiments, the feedback data includes a score card data corresponding to a score card. Further, the score card includes a score corresponding to the one or more physical activities performed by the one or more primary entities.

In some embodiments, the one or more content data includes one or more videos. Further, the feedback includes an insight on the one or more physical activities performed by the one or more primary entities. Further, the feedback data includes an overlay data comprising each of the one or more videos and the feedback. Further, the insight may be overlaid on the one or more videos.

In some embodiments, the one or more content data includes one or more videos. Further, the feedback includes a performance metric on the one or more physical activities performed by the one or more primary entities. Further, the feedback data includes an overlay data comprising each of the one or more videos and the feedback. Further, the performance metric may be overlaid on the one or more videos.

In some embodiments, the determining of the one or more associations between the one or more first entities and the one or more second entities in the one or more physical activities may be based on the analyzing of each of the two or more content data using the one or more tracking algorithms to maintain consistent entity association through one or more of an occlusion and a complex interaction.

In some embodiments, the one or more physical activities include one or more sports activities. Further, the determining of the one or more associations includes determining the one or more associations between the one or more first entities and the one or more second entities using one or more association algorithms based on the analyzing of the one or more content data using the one or more tracking algorithms. Further, the one or more association algorithms may be configured to determine the one or more associations associated with the one or more sport activities.

In some embodiments, the one or more association algorithms may be configured to determine the one or more associations associated with the one or more sport activities based on one or more sport-specific rules.

In some embodiments, the determining of the one or more associations includes determining the one or more associations between the one or more first entities and the one or more second entities using one or more association algorithms comprises determining the one or more associations between the one or more first entities and the one or more second entities using one of two or more association algorithms. Further, the two or more association algorithms correspond to two or more sports types. Further, the two or more association algorithms may be configured to incorporate two or more sport-specific rules.

In some embodiments, the one or more association algorithms may be configured to determine the one or more associations corresponding to one or two or more sports equipment.

In some embodiments, the one or more association algorithms may be configured to determine the one or more associations associated with the one or more sport activities based on one or more sport-specific movement patterns.

In some embodiments, the method may further include storing, using a storage device, the composite object data in one or more databases.

In some embodiments, the method 900 may further include retrieving, using the storage device, the composite object data from the one or more databases. Further, the identifying of the one or more parts of the one or more content data is further based on the retrieving of the composite object data. Further, the one or more parts of the one or more content data correspond to the composite object.

FIG. 10 illustrates a process 1000 of provisioning feedback on a physical activity of a composite object, in accordance with some embodiments. Further, the process 1000 includes receiving a content data 1002. Further, the content data 1002 comprises a video of a plurality of players (1006-1016) performing a sports activity using a plurality of sports objects. Further, the plurality of sports objects comprises a ball 1004, a hoop 1020, and a pole 1022. Further, the process 1000 includes identifying an association between the ball 1004 and a player 1006. Further, the process 1000 includes creating 1024 a composite object 1026 based on the identifying of the association. Further, the composite object 1026 comprises each of the player 1006 and the ball 1004. Further, the process 1000 comprises analyzing 1028 a plurality of biomechanical characteristics (1030-1060) of the player 1006. Further, the process 1000 comprises transmitting a feedback data 1064 to a user device 1062. Further, the user device 1062 is configured to present the feedback data.

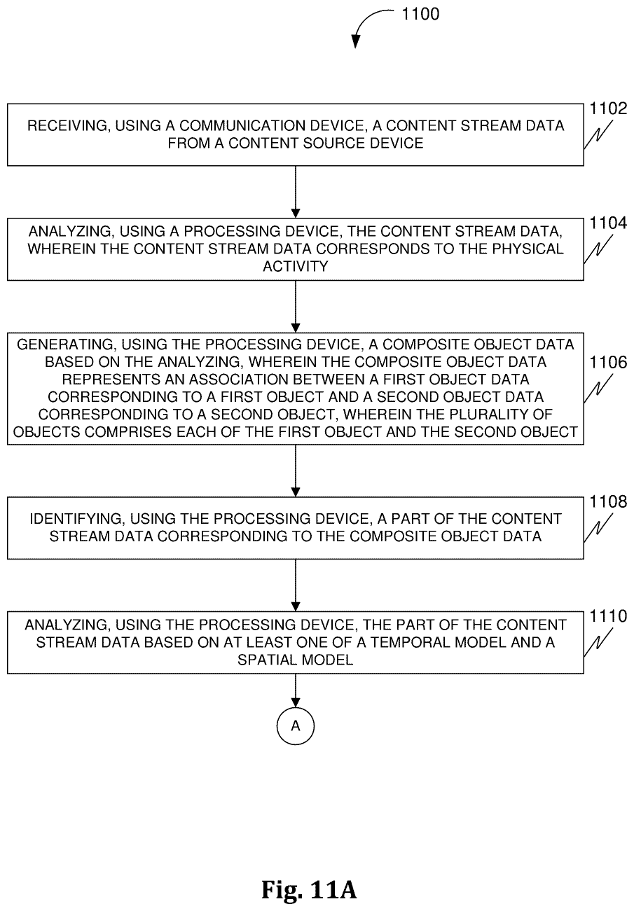

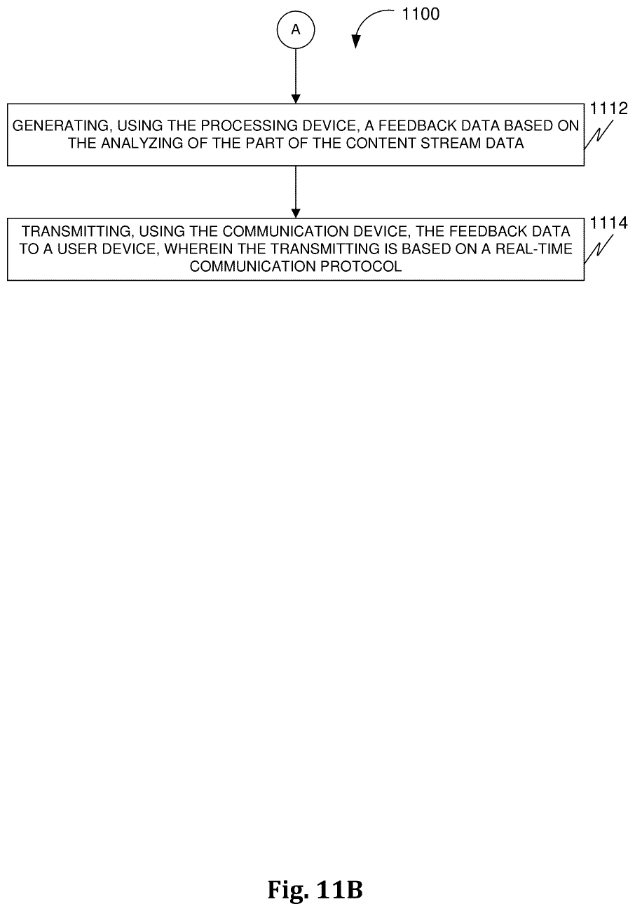

FIG. 11A and FIG. 11B illustrate a flowchart of a method 1100 for dynamic player-entity association and performance analysis in sports, in accordance with some embodiments. Further, the method 1100 may include a step 1102 of receiving, using a communication device 802, a content stream data from a content source device. Further, the method 1100 may include a step 1104 of analyzing, using a processing device 804, the content stream data. Further, the content stream data corresponds to the physical activity. Further, the method 1100 may include a step 1106 of generating, using the processing device 804, a composite object data based on the analyzing. Further, the composite object data represents an association between a first object data corresponding to a first object and a second object data corresponding to a second object. Further, the two or more objects include each of the first object and the second object. Further, the method 1100 may include a step 1108 of identifying, using the processing device 804, a part of the content stream data corresponding to the composite object data. Further, the method 1100 may include a step 1110 of analyzing, using the processing device 804, the part of the content stream data based on one or more of a temporal model and a spatial model. Further, the method 1100 may include a step 1112 of generating, using the processing device 804, a feedback data based on the analyzing of the part of the content stream data. Further, the method 1100 may include a step 1114 of transmitting, using the communication device 802, the feedback data to a user device. Further, the transmitting may be based on a real-time communication protocol.

In some embodiments, the composite object data represents an association between two or more object data corresponding to two or more objects.

In some embodiments, the content stream data includes a video data. Further, the video data includes two or more video frame data. Further, the two or more video frame data correspond to two or more video frames. Further, the physical activity includes a sport. Further, the first object includes a player. Further, the second object includes a sport object.

In some embodiments, the analyzing of the content stream data includes assigning two or more object data to the two or more objects. Further, the two or more object data includes two or more player data corresponding to the two or more players and a sport object data corresponding to the sport object. Further, the two or more player data includes two or more player identifiers. Further, the sport object data includes a sport object identifier.

In some embodiments, the analyzing of the content stream data further includes identifying each of the two or more player data and the sport object data.

In some embodiments, the analyzing of the content stream data is based on a tracking algorithm.

In some embodiments, the association represents a physical contact between the first object and the second object.

In some embodiments, the temporal model may be trained based on a temporal data. Further, the temporal data includes a three dimensional posture data. Further, the three dimensional posture data corresponds to a three-dimensional posture of a player performing the physical activity.

In some embodiments, the spatial model may be trained based on a spatial data. Further, the spatial data corresponds to a three-dimensional spatial position data, three-dimensional spatial position data corresponds to position of a player performing the physical activity.

In some embodiments, the feedback data includes a metric corresponding to a characteristic of the physical activity. Further, the generating of the feedback data includes comparing the metric with a reference metric. Further, the reference metric corresponds to the characteristic.

In some embodiments, the characteristic includes two or more characteristics. Further, the two or more characteristics include one or more first characteristics of the first object and one or more second characteristics of the second object.

In some embodiments, the feedback data represents one or more of a progress and a regression in the performance of the physical activity.

The present disclosure provides a system 800 for dynamic player-entity association and performance analysis in sports. Further, the system 800 may include a communication device 802. Further, the communication device 802 may be configured for receiving a content stream data from a content source device. Further, the communication device 802 may be configured for transmitting a feedback data to a user device. Further, the transmitting may be based on a real-time communication protocol. Further, the system 800 may include a processing device 804. Further, the processing device 804 may be configured for analyzing the content stream data. Further, the content stream data corresponds to the physical activity. Further, the physical activity is associated with a plurality of objects. Further, the processing device 804 may be configured for generating a composite object data based on the analyzing. Further, the composite object data represents an association between a first object data corresponding to a first object and a second object data corresponding to a second object. Further, the two or more objects includes each of the first object and the second object. Further, the processing device 804 may be configured for identifying a part of the content stream data corresponding to the composite object data. Further, the processing device 804 may be configured for analyzing the part of the content stream data based on one or more of a temporal model and a spatial model. Further, the processing device 804 may be configured for generating the feedback data based on the analyzing of the part of the content stream data.

In some embodiments, the composite object data represents an association between two or more object data corresponding to two or more objects.

In some embodiments, the content stream data includes a video data. Further, the video data includes two or more video frame data. Further, the two or more video frame data correspond to two or more video frames. Further, the physical activity includes a sport. Further, the first object includes a player. Further, the second object includes a sport object.

In some embodiments, the analyzing of the content stream data includes assigning two or more object data to the two or more objects. Further, the two or more object data includes two or more player data corresponding to the two or more players and a sport object data corresponding to the sport object. Further, the two or more player data includes two or more player identifiers. Further, the sport object data includes a sport object identifier.

In some embodiments, the analyzing of the content stream data further includes identifying each of the two or more player data and the sport object data.

In some embodiments, the analyzing of the content stream data is based on a tracking algorithm.

In some embodiments, the association represents a physical contact between the first object and the second object.

In some embodiments, the temporal model may be trained based on a temporal data. Further, the temporal data includes a three dimensional posture data. Further, the three dimensional posture data corresponds to a three-dimensional posture of a player performing the physical activity.

In some embodiments, the spatial model may be trained based on a spatial data. Further, the spatial data corresponds to a three-dimensional spatial position data, three-dimensional spatial position data corresponds to position of a player performing the physical activity.

In some embodiments, the feedback data includes a metric corresponding to a characteristic of the physical activity. Further, the generating of the feedback data includes comparing the metric with a reference metric. Further, the reference metric corresponds to the characteristic.

In some embodiments, the characteristic includes two or more characteristics. Further, the two or more characteristics include one or more first characteristics of the first object and one or more second characteristics of the second object.

In some embodiments, the feedback data represents one or more of a progress and a regression in the performance of the physical activity.

In some embodiments, the composite object data includes an association data representing an association between a player identifier and the sport object identifier. Further, the player identifier represents a player associated with the sport object.

In some embodiments, the composite object. Further, the composite object data corresponds to a time instant. Further, the association between the first object and the second object exists at the time instant.

In some embodiments, the composite object data corresponds to a time interval. Further, the association between the first object and the second object exists during the time interval.

In some embodiments, the association represents a physical contact between the first object and the second object occurring during a time interval.

In some embodiments, the association represents a physical contact between the first object and the second object occurring during a time interval exceeding a predetermined time duration.

In some embodiments, the association represents the first object controlling one or more second characteristics of the second object.

In some embodiments, the one or more second characteristics include one or more of a position, a motion, and an orientation of the second object in relation to one or more of the first object and a field corresponding to the physical activity.

In some embodiments, the association represents the first object being spatially proximal to the second object within a predetermined distance.

In some embodiments, the first object may be associated with a first movement. Further, at least one first characteristic of the first object includes a first direction of movement. Further, the second object may be associated with a second movement. Further, the one or more second characteristics of the second object include a second direction of movement. Further, an angular separation between the second direction of movement and the first direction of the movement may be within a predetermined range.

In some embodiments, the first object includes one or more parts. Further, the one or more parts may be associated with a first characteristic. Further, the first characteristic includes one or more of a position and a motion of the one or more parts. Further, the position of the second object may be spatially proximal to the position of the first object. Further, the motion of the second object may be proximal to the motion of the one or more parts.

In some embodiments, the second object includes two or more sport objects. Further, the two or more sport objects include a first sport object and a second sport object. Further, the first sport object may be associated with one or more first sport object characteristics. Further, the second sport object may be associated with one or more second sport object characteristics. Further, the generating of the composite object data may be based on an association rule. Further, the association rule may be based on each of the one or more first sport object characteristics and the one or more second sport object characteristics. Further, the association rule may be satisfied.

In some embodiments, the first sport object may be associated with a first sport object movement. Further, at least one first sport object characteristic of the first sport object includes a first sport object direction of movement. Further, the second sport object may be associated with a second sport object movement. Further, the one or more characteristics of the second sport object include a second sport object direction of movement. Further, an angular separation between the second sport object direction of movement and the first sport object direction of the movement may be within a predetermined range.

In some embodiments, the association rule represents the first sport object being spatially proximal to the second sport object within a predetermined distance.

In some embodiments, the physical activity corresponds to Ice Hockey. Further, the first object corresponds to a hockey stick. Further, the second object corresponds to a puck.

In some embodiments, the second object data includes a sport object identifier.

In some embodiments, the sport object corresponds to a ball.

In some embodiments, the sport object corresponds to a puck.

In some embodiments, the analyzing of the content stream data further includes generating a position data corresponding to a position in relation to one or more of a field corresponding to the physical activity and a video frame of the two or more video frames. Further, the position may be associated with one or more of the two or more objects.

In some embodiments, the field corresponds to an environment associated with the physical activity.

In some embodiments, the position data corresponding to a primary position. Further, the analyzing of the content stream data further includes identifying a primary player based on the position data. Further, the primary player may be associated with the primary position.

In some embodiments, the primary position may have a proximity to a center point of the two or more video frames. Further, the center point may be located at middle of the two or more video frames.

In some embodiments, the position data corresponds to the two or more positions of the two or more objects. Further, the two or more objects includes a first player and a second player. Further, the two or more position data includes a first player position data corresponding to a first position of the first player and a second player position data corresponding to a second position of the second player. Further, the first player position data represents a distance of the first player from the center point. Further, the second player position data represents a distance of the second player from the center point. Further, the distance of the second player may be larger than the distance of the first player. Further, the primary player corresponds to a first player.

In some embodiments, the position may be based on a spatial configuration rule. Further, the spatial configuration rule corresponds to the positioning rule for the two or more objects in the field based on a sport type.

In some embodiments, the identifying of the primary player may be further based on movement patterns of one or more players. Further, the each of the two or more players may be associated with the movement patterns. Further, the movement pattern of the one or more players may be based on a predefined movement patterns based on a sport type.

In some embodiments, the movement patterns may be based on a situation associated with the physical activity.

In some embodiments, the physical activity includes two or more phases. Further, the movement pattern may be based on the two or more phases.

In some embodiments, the physical activity corresponds to Basketball. Further, the primary player corresponds to a shooter. Further, the identifying of the primary player may be based on one or more of the association and the movement pattern. Further, the movement pattern may be based on the two or more phases.

In some embodiments, the two or more phases include a transfer phase, a pocket phase and a release phase.

In some embodiments, the physical activity corresponds to Football. Further, the primary player corresponds to a ball holder. Further, the identifying of the primary player may be based on one or more of the association and the movement pattern.

In some embodiments, the physical activity corresponds to Hockey. Further, the primary player corresponds to a goalkeeper. Further, the identifying of the primary player may be based on the spatial configuration rule and the primary position.

In some embodiments, the primary position may have a proximity to a center point of the two or more video frames. Further, the center point may be located at middle of the two or more video frames.

In some embodiments, the spatial configuration rule includes a goalkeeper positioning rule. Further, the goalkeeper positioning rule represents a positioning of the goalkeeper. Further, the goalkeeper may be positioned within a defensive zone in the field.

In some embodiments, the defensive zone corresponds to a specific area in the field to prevent a goal.

In some embodiments, the analyzing of the part of the content stream data may be based on each of one or more first characteristics of the first object and one or more second characteristics of the second object.

In some embodiments, the user device may be configured to present the feedback data over a video data.

In some embodiments, the feedback data corresponds a key action. Further, the physical activity corresponds to a sport activity. Further, the key action corresponds to an action that is required to achieve a goal.

In some embodiments, the user device may be configured to execute one or more of an application and a browser.

In some embodiments, the one or more of the application and the browser may be configured to present the feedback data on a presentation device associated with the user device.

In some embodiments, the feedback data may be used to provide training to a player performing the physical activity.

In some embodiments, the feedback data corresponds to a suggestion to improve a performance of the player.

In some embodiments, the feedback data corresponds to an insight based on a performance of a player performing the physical activity.

In some embodiments, the feedback data corresponds to a report based on a performance of a player performing the physical activity.

In some embodiments, the feedback data includes a score based on a performance of a player performing the physical activity.

In some embodiments, the real-time communication protocol corresponds to one or more of a WebRTC (or similar), a Websockets (or similar), a real-time streaming protocol, a real-time transfer protocol, and a live-streaming protocol.

In some embodiments, the content source device corresponds to a camera.

In some embodiments, the user device may be associated with a user.

In some embodiments, the user corresponds to a sport coach.

In some embodiments, the one or more first characteristics of the first object a biomechanical characteristic. Further, the biomechanical characteristic corresponds to a mechanics of the two or more players.

In some embodiments, the one or more characteristics of the second object corresponds to a mechanics of the sport object.

In some embodiments, the physical activity may be associated with a crowded sport environment. Further, the crowded sport environment includes the two or more objects.

In some embodiments, the situation represents one or more of a part of the physical activity, an environmental condition associated with the physical activity, and a player condition associated with the player performing the physical activity.

In some embodiments, the metric may be based on a situation. Further, the situation represents one or more of a part of the physical activity, an environmental condition associated with the physical activity, and a player condition associated with a player performing the physical activity.

In some embodiments, the physical activity corresponds to Basketball. Further, the first object corresponds to a player performing the physical activity. Further, the one or more characteristics of the first object correspond to a player body alignment and ball release timing.

In some embodiments, the physical activity corresponds to Football. Further, the first object corresponds to a player performing of the physical activity. Further, the one or more characteristics of the first object correspond to a player movement, an agility of the player and decision making by the player.

In some embodiments, the agility corresponds to an ability of the player to move quickly.

In some embodiments, the decision making corresponds to a process of choosing different options by the player.

In some embodiments, the content stream data corresponds to Hockey. Further, the first object corresponds to a player performing the physical activity. Further, the one or more characteristics of the first object correspond to a position of the player in the field and a response by the player.

In some embodiments, the player corresponds to a goal keeper. Further, the response corresponds to an action by the goalkeeper to protect a goal.

In some embodiments, the player corresponds to a goal keeper. Further, the position corresponds to positioning in the defensive zone.

In some embodiments, the player corresponds to a ball carrier.

In some embodiments, the player corresponds to a shooter.

In some embodiments, the sport object corresponds to a club.

In some embodiments, the sport object corresponds to a hockey stick.

In some embodiments, the two or more player identifiers correspond to two or more player names.

In some embodiments, the two or more player identifiers correspond to two or more player numbers.

In some embodiments, the sport object identifier corresponds to a sport object name.

In some embodiments, the body alignment of the player corresponds to positioning of different body parts of the player.

In some embodiments, the ball release timing corresponds to a time interval. Further, the player releases a ball over the time interval.

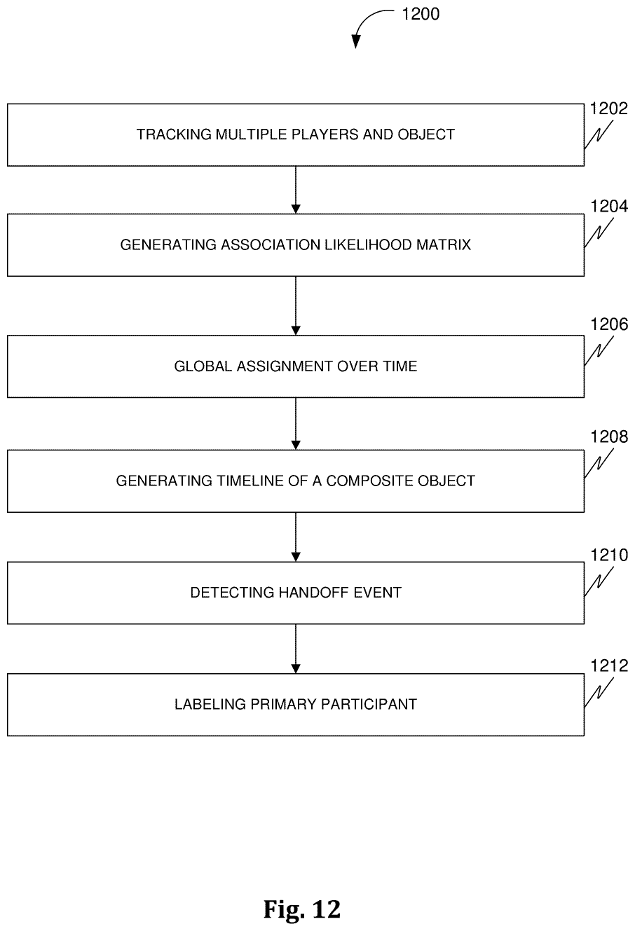

FIG. 12 illustrates a flowchart of a method 1200 of facilitating dynamic entity association, in accordance with some embodiments. Further, the method 1200 includes a step 1202 of tracking multiple players and objects. Further, the method 1200 includes a step 1204 of generating an association likelihood matrix. Further, the method 1200 includes a step 1206 of performing a global assignment over a time interval. Further, the method 1200 includes a step 1208 of generating a timeline of a composite object. Further, the method 1200 includes a step 1210 of detecting a handoff event. Further, the method 1200 includes a step 1212 of labeling a primary participant.

Although the invention has been explained in relation to its preferred embodiment, it is to be understood that many other possible modifications and variations can be made without departing from the spirit and scope of the invention as hereinafter claimed.

What is claimed is:

1. A method of facilitating dynamic entity association, the method comprising:
receiving, using a communication device, at least one content data from at least one content source device, wherein the at least one content data corresponds to at least one physical activity, wherein the at least one physical activity is associated with a plurality of entities;
analyzing, using a processing device, the at least one content data using at least one tracking algorithm, wherein the at least one tracking algorithm is configured to track the plurality of entities in the at least one content data; and
determining, using the processing device, at least one association between at least one first entity and at least one second entity in the at least one physical activity based on the analyzing of the at least one content data using the at least one tracking algorithm, wherein the plurality of entities comprises the at least one first entity and the at least one second entity.

2. The method of claim 1, wherein the determining of the at least one association comprises computing at least one association confidence score of the at least one association, wherein the at least one association confidence score quantifies an accuracy of the at least one association, wherein the method further comprises:
analyzing, using the processing device, the at least one association confidence score and an association confidence threshold, wherein the association confidence threshold comprises a minimum association confidence score of the at least one association;
determining, using the processing device, a result based on the analyzing of the at least one association confidence score and the association confidence threshold, wherein the result comprises one of a positive result and a negative result; and
generating, using the processing device, a feedback data based on the at least one content data and the determining of the result comprising the positive result, wherein the positive result indicates an exceedance of the at least one association confidence score in relation to the association confidence threshold.

3. The method of claim 1, wherein the analyzing of the at least one content data comprises analyzing the at least one content data based on at least one association rule, wherein the determining of the at least one association is based on the analyzing of the at least one content data based on the at least one association rule, wherein the at least one association rule comprises at least one of a time-based association rule and a frame-based association rule.

4. The method of claim 1 further comprises determining, using the processing device, a plurality of trajectories of the plurality of entities in the at least one physical activity based on the analyzing of the at least one content data using the at least one tracking algorithm, wherein the plurality of trajectories corresponds to a plurality of paths predicted to be followed by the plurality of entities in the at least one physical activity, wherein the determining of the at least one association between the at least one first entity and the at least one second entity is further based on the plurality of trajectories of the plurality of entities.

5. The method of claim 4 further comprising determining, using the processing device, at least one occlusion event of at least one of the plurality of entities in the at least one content data based on the analyzing of the at least one content data, wherein the at least one occlusion event of at least one of the plurality of entities corresponds to an occlusion of at least one of the plurality of entities in the at least one content data, wherein the determining of the at least one association is further based on the determining of the at least one occlusion event, wherein the determining of the at least one association comprises determining the at least one association in the at least one occlusion event based on the plurality of trajectories of the plurality of entities.

6. The method of claim 1, wherein the at least one content data comprises at least one video comprising a plurality of video frames, wherein the analyzing of the at least one content data comprises analyzing each of the plurality of video frames using the at least one tracking algorithm, wherein the determining of the at least one association between the at least one first entity and the at least one second entity in the at least one physical activity is based on the analyzing of each of the plurality of video frames using the at least one tracking algorithm, wherein the at least one tracking algorithm is configured to track the plurality of entities in each of the plurality of video frames using a multi-frame optimization technique.

7. The method of claim 1 further comprising:
generating, using the processing device, at least one spatial data based on the analyzing of the at least one content data using the at least one tracking algorithm, wherein the at least one spatial data indicates at least one spatial configuration of the plurality of entities;
generating, using the processing device, at least one temporal data based on the analyzing of the at least one content data using the at least one tracking algorithm, wherein the at least one temporal data indicates at least one temporal behavior pattern of the plurality of entities; and
analyzing, using the processing device, each of the at least one temporal data and the at least one spatial data of the plurality of entities, wherein the determining of the at least one association is further based on the analyzing of each of the at least one temporal data and the at least one spatial data of the plurality of entities.

8. The method of claim 1, wherein the at least one first entity comprises a plurality of first entities, wherein the at least one second entity comprises a plurality of second entities, wherein the determining of the at least one association comprises determining a plurality of associations between the plurality of first entities and the plurality of second entities, wherein the at least one content data comprises at least one video comprising a plurality of video frames, wherein the method further comprises:
generating, using the processing device, a plurality of position data of the plurality of first entities in at least one of the plurality of video frames based on the determining of the plurality of associations, wherein the plurality of position data indicates a plurality of positions of the plurality of first entities in at least one of the plurality of video frames;
analyzing, using the processing device, the plurality of position data of the plurality of first entities based on a center position data, wherein the center position data indicates a center position of at least one of the plurality of video frames; and
identifying, using the processing device, at least one primary entity from the plurality of entities based on the analyzing of the plurality of position data.

9. The method of claim 8 further comprising determining, using the processing device, a plurality of proximity data based on the analyzing of the plurality of position data of the plurality of first entities based on the center position data, wherein the plurality of proximity data indicates a proximity of the plurality of entities to the center position of at least one of the plurality of video frames, wherein the identifying of the at least one primary entity from the plurality of first entities is further based on the determining of the plurality of proximity data.

10. The method of claim 1 further comprising:
assigning, using the processing device, a plurality of identifiers to the plurality of entities using the at least one tracking algorithm, wherein the analyzing of the at least one content data is further based on the assigning of the plurality of identifiers, wherein the analyzing of the at least one content data comprises analyzing the plurality of entities in the at least one content data using the at least one tracking algorithm based on the plurality of identifiers, wherein the at least one tracking algorithm is configured to track the plurality of entities in the at least one content data based on the plurality of identifiers; and
generating, using the processing device, a composite object data based on the determining of the at least one association and the plurality of identifiers, wherein the composite objet data corresponds to a composite object comprising each of the at least one first entity and the at least one second entity, wherein the composite objet data comprises each of at least one first identifier of the at least one first entity, at least one second identifier of the at least one second entity, a time interval of the at least one association, and at least one association confidence score of the at least one association, wherein the plurality of identifiers comprises the at least one first identifier and the at least one second identifier.

11. A system for facilitating dynamic entity association, the system comprising:
a communication device configured for receiving at least one content data from at least one content source device, wherein the at least one content data corresponds to at least one physical activity, wherein the at least one physical activity is associated with a plurality of entities; and
a processing device communicatively coupled with the communication device, wherein the processing device is configured for:
analyzing the at least one content data using at least one tracking algorithm, wherein the at least one tracking algorithm is configured to track the plurality of entities in the at least one content data; and
determining at least one association between at least one first entity and at least one second entity in the at least one physical activity based on the analyzing of the at least one content data using the at least one tracking algorithm, wherein the plurality of entities comprises the at least one first entity and the at least one second entity.

12. The system of claim 11, wherein the determining of the at least one association comprises computing at least one association confidence score of the at least one association, wherein the at least one association confidence score quantifies an accuracy of the at least one association, wherein the processing device is further configured for:
analyzing the at least one association confidence score and an association confidence threshold, wherein the association confidence threshold comprises a minimum association confidence score for the at least one association;
determining a result based on the analyzing of the at least one association confidence score and the association confidence threshold, wherein the result comprises one of a positive result and a negative result; and
generating a feedback data based on the at least one content data and the determining of the result comprising the positive result, wherein the positive result indicates an exceedance of the at least one association confidence score in relation to the association confidence threshold.

13. The system of claim 11, wherein the analyzing of the at least one content data comprises analyzing the at least one content data based on at least one association rule, wherein the determining of the at least one association is based on the analyzing of the at least one content data based on the at least one association rule, wherein the at least one association rule comprises at least one of a time-based association rule and a frame-based association rule.

14. The system of claim 11, wherein the processing device is further configured for determining a plurality of trajectories of the plurality of entities in the at least one physical activity based on the analyzing of the at least one content data using the at least one tracking algorithm, wherein the plurality of trajectories corresponds to a plurality of paths predicted to be followed by the plurality of entities in the at least one physical activity, wherein the determining of the at least one association between the at least one first entity and the at least one second entity is further based on the plurality of trajectories of the plurality of entities.

15. The system of claim 14, wherein the processing device is further configured for determining at least one occlusion event of at least one of the plurality of entities in the at least one content data based on the analyzing of the at least one content data, wherein the at least one occlusion event of at least one of the plurality of entities corresponds to an occlusion of at least one of the plurality of entities in the at least one content data, wherein the determining of the at least one association is further based on the determining of the at least one occlusion event, wherein the determining of the at least one association comprises determining the at least one association in the at least one occlusion event based on the plurality of trajectories of the plurality of entities.

16. The system of claim 11, wherein the at least one content data comprises at least one video comprising a plurality of video frames, wherein the analyzing of the at least one content data comprises analyzing each of the plurality of video frames using the at least one tracking algorithm, wherein the determining of the at least one association between the at least one first entity and the at least one second entity in the at least one physical activity is based on the analyzing of each of the plurality of video frames using the at least one tracking algorithm, wherein the at least one tracking algorithm is configured to track the plurality of entities in each of the plurality of video frames using a multi-frame optimization technique.

17. The system of claim 11, wherein the processing device is further configured for:
generating at least one spatial data based on the analyzing of the at least one content data using the at least one tracking algorithm, wherein the at least one spatial data indicates at least one spatial configuration of the plurality of entities;
generating at least one temporal data based on the analyzing of the at least one content data using the at least one tracking algorithm, wherein the at least one temporal data indicates at least one temporal behavior pattern of the plurality of entities; and
analyzing each of the at least one temporal data and the at least one spatial data of the plurality of entities, wherein the determining of the at least one association is further based on the analyzing of each of the at least one temporal data and the at least one spatial data of the plurality of entities.

18. The system of claim 11, wherein the at least one first entity comprises a plurality of first entities, wherein the at least one second entity comprises a plurality of second entities, wherein the determining of the at least one association comprises determining a plurality of associations between the plurality of first entities and the plurality of second entities, wherein the at least one content data comprises at least one video comprising a plurality of video frames, wherein the processing device is further configured for:
generating a plurality of position data of the plurality of first entities in at least one of the plurality of video frames based on the determining of the plurality of associations, wherein the plurality of position data indicates a plurality of positions of the plurality of first entities in at least one of the plurality of video frames;
analyzing the plurality of position data of the plurality of first entities based on a center position data, wherein the center position data indicates a center position of at least one of the plurality of video frames; and
identifying at least one primary entity from the plurality of entities based on the analyzing of the plurality of position data.

19. The system of claim 18, wherein the processing device is further configured for determining a plurality of proximity data based on the analyzing of the plurality of position data of the plurality of first entities based on the center position data, wherein the plurality of proximity data indicates a proximity of the plurality of entities to the center position of at least one of the plurality of video frames, wherein the identifying of the at least one primary entity from the plurality of first entities is further based on the determining of the plurality of proximity data.

20. The system of claim 11, wherein the processing device is further configured for:
assigning a plurality of identifiers to the plurality of entities using the at least one tracking algorithm, wherein the analyzing of the at least one content data is further based on the assigning of the plurality of identifiers, wherein the analyzing of the at least one content data comprises analyzing the plurality of entities in the at least one content data using the at least one tracking algorithm based on the plurality of identifiers, wherein the at least one tracking algorithm is configured to track the plurality of entities in the at least one content data based on the plurality of identifiers; and
generating a composite object data based on the determining of the at least one association and the plurality of identifiers, wherein the composite objet data corresponds to a composite object comprising each of the at least one first entity and the at least one second entity, wherein the composite objet data comprises each of at least one first identifier of the at least one first entity, at least one second identifier of the at least one second entity, a time interval of the at least one association, and at least one association confidence score of the at least one association, wherein the plurality of identifiers comprises the at least one first identifier and the at least one second identifier.
